(19) United States
(12) Patent Application Publication
(10) Pub. No.: US 2018/0136632 A1
(43) Pub. Date: May 17, 2018

(54) INFORMATION PROCESSING APPARATUS AND INFORMATION PROCESSING METHOD

(71) Applicant: CANON KABUSHIKI KAISHA, Tokyo (JP)

(72) Inventor: Takashi Ochiai, Machida-shi (JP)

(21) Appl. No.: 15/578,632

(22) PCT Filed: May 30, 2016
(86) PCT No.: PCT/JP2016/002606

§ 371 Date: Nov. 30, 2017

(30) Foreign Application Priority Data
Jun. 5, 2015 (JP) 2015-115169

(51) Int. Cl. G05B 19/4097; B33Y 50/00; B29C 64/386; G06F 17/50

(52) U.S. Cl. CPC G05B 19/4097; B33Y 50/00; B29C 64/112; G06F 17/50; B29C 64/386

(57) ABSTRACT

An information processing apparatus according to the present invention includes an input unit configured to input solid shape data expressing a shape of a solid object, and a generation unit configured to generate first data and second data from the solid shape data, the first data including a unit component in molding the solid object, the second data including a unit component to be formed using a dot of color material on a surface of a solid object expressed by the first data, the unit component of the second data being smaller than the unit component of the first data.

### TECHNICAL FIELD

The present invention relates to information processing for generating data for molding a solid object.

### BACKGROUND ART

Additive manufacturing has heretofore been known as solid molding technology for molding a three-dimensional solid object. The additive manufacturing is a method for molding a three-dimensional solid object by stacking layers of molding material, such as powder, resin, steel sheets, and paper. Examples of various methods for additive manufacturing include an inkjet method, stereolithography, powder sintering, powder binding (inkjet binder method), and fused deposition modeling.

For example, in the inkjet method, a molding material is splayed from a nozzle or nozzles of an inkjet head and is stacked in layers so that a solid object is molded. In stereolithography, a liquid resin is irradiated with ultraviolet rays to be partly successively cured and is stacked in layers so that a solid object is molded. In the powder sintering, powder is spread in a layer and the layers of the powder directly sintered by a laser beam are stacked in layers so that a solid object is molded. In the powder binding (inkjet binder method), powder is spread in a layer and the layers of the powder bound with a binder applied by an inkjet method are stacked so that a solid object is molded. In the fused deposition modeling, a thermoplastic resin (such as acrylonitrile-butadiene-styrene (ABS) resin and polycarbonate resin) is melted at high temperature and stacked in layers so that a solid object is molded.

According to a conventional technique discussed in PTL 1, slice data is generated by slicing data expressing a shape of a solid object in a stacking direction of layers and a combined body of each layer is successively stacked in layers on a stage based on the generated slice data so that a desired solid object is molded.

However, according to the conventional technology, there is a tradeoff between molding precision and molding time of a solid object. More specifically, in order for a solid object to be molded with high definition, voxels which are the minimum unit of material in molding are formed smaller so that layers are formed thinner and more layers are stacked whereby a solid object can be molded with high definition. However, as the voxels are set to be smaller, the molding time of the solid object becomes longer.

Meanwhile, in order for a solid object to be molded at high speed, voxels for molding a solid object are formed larger so that layers are thickened and fewer layers are required to be stacked whereby the solid object can be molded at high speed. However, as the voxels are set to be larger, the molding precision of the solid object is reduced.

### CITATION LIST

### Patent Literature

PTL 1: Japanese Patent Application Laid-Open No. 2004-90530

### SUMMARY OF INVENTION

### Solution to Problem

The present invention is directed to generating data for molding a solid object with higher definition at higher speed than the case of molding a solid object using a single type of voxels.

According to an aspect of the present invention, an information processing apparatus includes an input unit configured to input solid shape data expressing a shape of a solid object, and a generation unit configured to generate first data and second data from the solid shape data, the first data including a unit component in molding the solid object, the second data including a unit component to be formed using a dot of color material on a surface of a solid object expressed by the first data, the unit component of the second data being smaller than the unit component of the first data.

Further features of the present invention will become apparent from the following description of exemplary embodiments with reference to the attached drawings.

### BRIEF DESCRIPTION OF DRAWINGS

FIG. 1 is a block diagram illustrating a configuration of a solid molding apparatus according to a first exemplary embodiment.

FIG. 2 is a schematic diagram illustrating a state of conventional solid molding.

FIG. 3 is a schematic diagram illustrating a state of solid molding according to the first exemplary embodiment.

FIG. 4 is a flowchart of processing for molding a solid object according to the first exemplary embodiment.

FIG. 5A is a schematic diagram illustrating a first voxel according to the first exemplary embodiment.

FIG. 5B is a schematic diagram illustrating a second voxel according to the first exemplary embodiment.

FIG. 6A is a schematic diagram three-dimensionally illustrating a solid object to be molded according to the first exemplary embodiment.

FIG. 6B is a schematic diagram three-dimensionally illustrating a solid object to be molded according to the first exemplary embodiment.

FIG. 6C is a schematic diagram three-dimensionally illustrating a solid object to be molded according to the first exemplary embodiment.

FIG. 7A is a schematic diagram illustrating a cross section of a solid object in the process of molding the solid object according to the first exemplary embodiment.

FIG. 7B is a schematic diagram illustrating a cross section of the solid object in the process of molding the solid object according to the first exemplary embodiment.

FIG. 7C is a schematic diagram illustrating a cross section of the solid object in the process of molding the solid object according to the first exemplary embodiment.

FIG. 7D is a schematic diagram illustrating a cross section of the solid object in the process of molding the solid object according to the first exemplary embodiment.

FIG. 7E is a schematic diagram illustrating a cross section of the solid object in the process of molding the solid object according to the first exemplary embodiment.

FIG. 7F is a schematic diagram illustrating a cross section of the solid object in the process of molding the solid object according to the first exemplary embodiment.

FIG. 7G is a schematic diagram illustrating a cross section of the solid object in the process of molding the solid object according to the first exemplary embodiment.

FIG. 7H is a schematic diagram illustrating a cross section of the solid object in the process of molding the solid object according to the first exemplary embodiment.

FIG. 7I is a schematic diagram illustrating a cross section of the solid object in the process of molding the solid object according to the first exemplary embodiment.

FIG. 7J is a schematic diagram illustrating a cross section of a solid object in the process of molding the solid object according to the first exemplary embodiment.

FIG. 8A is a schematic diagram illustrating a cross section of the solid object according to the first exemplary embodiment,

FIG. 8B is a schematic diagram illustrating a cross section of conventional solid objects.

FIG. 8C is a schematic diagram illustrating a cross section of conventional solid objects.

FIG. 9A is a schematic diagram illustrating a first voxel according to a second exemplary embodiment.

FIG. 9B is a schematic diagram illustrating a second voxel according to a second exemplary embodiment.

FIG. 10 is a schematic diagram illustrating a cross section of a solid object according to the second exemplary embodiment.

FIG. 11A is a schematic diagram illustrating a cross section of a solid object in the process of molding the solid object according to the second exemplary embodiment.

FIG. 11B is a schematic diagram illustrating a cross section of the solid object in the process of molding the solid object according to the second exemplary embodiment.

FIG. 11C is a schematic diagram illustrating a cross section of the solid object in the process of molding the solid object according to the second exemplary embodiment.

FIG. 11D is a schematic diagram illustrating a cross section of the solid object in the process of molding the solid object according to the second exemplary embodiment.

FIG. 11E is a schematic diagram illustrating a cross section of the solid object in the process of molding the solid object according to the second exemplary embodiment.

FIG. 11F is a schematic diagram illustrating a cross section of the solid object in the process of molding the solid object according to the second exemplary embodiment.

FIG. 11G is a schematic diagram illustrating a cross section of the solid object in the process of molding the solid object according to the second exemplary embodiment.

FIG. 11H is a schematic diagram illustrating a cross section of the solid object in the process of molding the solid object according to the second exemplary embodiment.

FIG. 11I is a schematic diagram illustrating a cross section of the solid object in the process of molding the solid object according to the second exemplary embodiment.

FIG. 11J is a schematic diagram illustrating a cross section of the solid object in the process of molding the solid object according to the second exemplary embodiment.

FIG. 11K is a schematic diagram illustrating a cross section of the solid object in the process of molding the solid object according to the second exemplary embodiment.

FIG. 11L is a schematic diagram illustrating a cross section of the solid object in the process of molding the solid object according to the second exemplary embodiment.

FIG. 11M is a schematic diagram illustrating a cross section of the solid object in the process of molding the solid object according to the second exemplary embodiment.

FIG. 11N is a schematic diagram illustrating a cross section of the solid object in the process of molding the solid object according to the second exemplary embodiment.

FIG. 11O is a schematic diagram illustrating a cross section of the solid object in the process of molding the solid object according to the second exemplary embodiment.

FIG. 12 is a block diagram illustrating a configuration of a solid molding apparatus according to a third exemplary embodiment.

FIG. 13 is a flowchart of processing for molding a solid object according to the third exemplary embodiment.

FIG. 14A is a schematic diagram illustrating a method for generating first shape data based on solid shape data according to the third exemplary embodiment.

FIG. 14B is a schematic diagram illustrating a method for generating second shape data based on solid shape data according to the third exemplary embodiment.

FIG. 15A is a schematic diagram illustrating a method for generating first shape slice data according to the third exemplary embodiment.

FIG. 15B is a schematic diagram illustrating a method for generating second shape slice data according to the third exemplary embodiment.

FIG. 15C is a schematic diagram illustrating a method for generating first shape slice data and second shape slice data according to the third exemplary embodiment.

FIG. 16 is a block diagram illustrating a configuration of a solid molding apparatus according to a fourth exemplary embodiment.

FIG. 17 is a flowchart of processing for molding a solid object according to the fourth exemplary embodiment.

FIG. 18 is a block diagram illustrating a configuration of a solid molding apparatus according to a fifth exemplary embodiment.

FIG. 19 is a flowchart of processing for molding a solid object according to the fifth exemplary embodiment.

FIG. 20A is a schematic diagram illustrating an uneven shape or a solid object among various types according to the present exemplary embodiment.

FIG. 20B is a schematic diagram illustrating an uneven shape or a solid object among various types according to the present exemplary embodiment.

FIG. 20C is a schematic diagram illustrating an uneven shape or a solid object among various types according to the present exemplary embodiment.

FIG. 20D is a schematic diagram illustrating an uneven shape or a solid object among various types according to the present exemplary embodiment.

FIG. 20E is a schematic diagram illustrating an uneven shape or a solid object among various types according to the present exemplary embodiment.

FIG. 21 is a schematic diagram illustrating a case where portions molded by first voxels are exposed in part of the surface of a solid molded article.

### DESCRIPTION OF EMBODIMENTS

Exemplary embodiments of the present invention will be described in detail below with reference to the drawings.

### First Exemplary Embodiment

<Configuration>

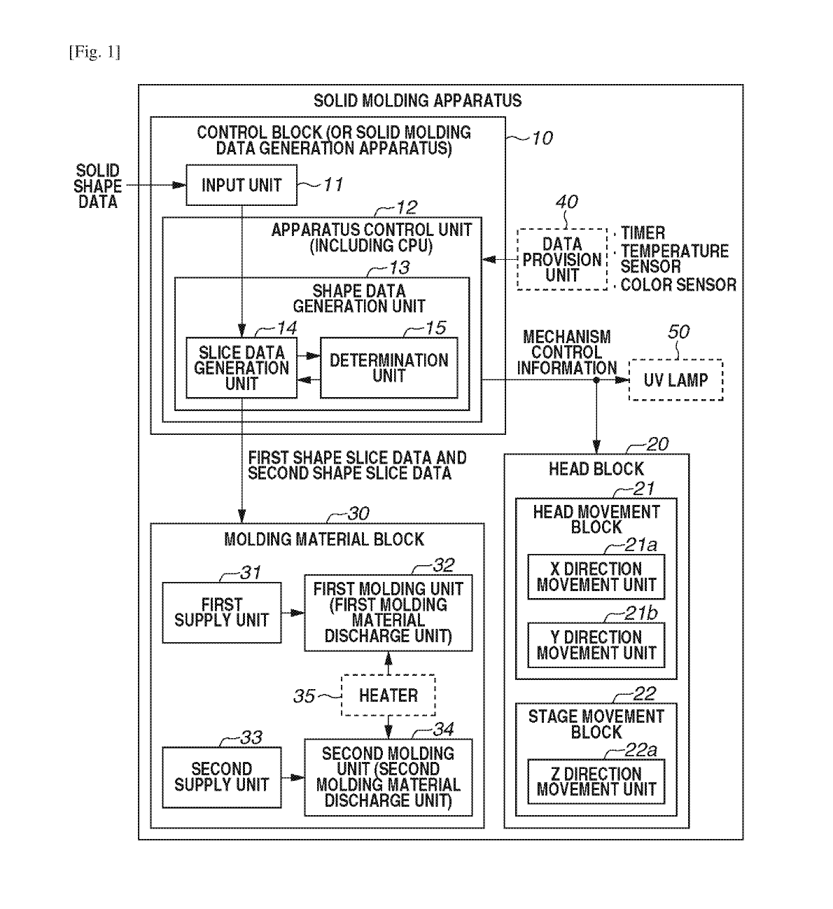

FIG. 1 is a block diagram illustrating a configuration of a solid molding apparatus according to a first exemplary embodiment. This solid molding apparatus is an apparatus for molding a solid object using the inkjet method, stereolithography, powder sintering, powder binding (inkjet binder method), fused deposition modeling, or the like. The solid molding apparatus includes a control block 10, a head block 20, and a molding material block 30. A data provision unit 40 for providing data for determining whether stacking of layers is completed, an ultraviolet (UV) lamp 50, and/or a heater 35 may be added if needed. Each component will be described below. The control block 10 may be configured as an information processing apparatus for generating data for solid molding. That is, the control block 10 may be configured as a generation apparatus for generating solid molding data, separate from the solid molding apparatus illustrated in FIG. 1.

<Control Block>

The control block 10 includes an input unit 11, an apparatus control unit 12, a shape data generation unit 13, a slice data generation unit 14, and a determination unit 15. The shape data generation unit 13 includes the slice data generation unit 14 and the determination unit 15.

The input unit 11 obtains solid shape data (such as computer-aided design (CAD) data and design data) expressing a solid shape of an object to be molded from a computer apparatus, and transfers the solid shape data to the apparatus control unit 12. For example, the solid shape data is expressed by a data format in which a solid shape is expressed as an aggregate of small triangles. The method for obtaining the solid shape data is not limited in particular. The solid shape data may be obtained using wired communication or wireless communication, such as short-range wireless communication, or using a recording medium, such as a Universal Serial Bus (USB) memory. The solid shape data may be directly obtained from a computer that designs the object to be molded, or from a server that manages/stores the solid shape data.

The apparatus control unit 12 includes an arithmetic unit, such as a central processing unit (CPU). The apparatus control unit 12 includes control units, such as the shape data generation unit 13, the slice data generation unit 14, and the determination unit 15.

The slice data generation unit 14 included in the shape data generation unit 13 generates data on each layer (hereinafter, referred to as slice data) for stacking layers of molding material to mold a solid object. The slice data may be generated from the solid shape data using a conventional method. In the present exemplary embodiment, the slice data is generated as data including voxels which are unit components in forming the molding material. The slice data generation unit 14 generates first shape slice data and second shape slice data from the slice data. The first shape slice data is shape data including first voxels for forming an interior of the solid object. The second shape sliced data corresponds to shape data including second voxels for forming a surface of the solid object. As employed herein, the surface of a solid object refers to a region that forms an outer side of an uneven shape or the solid object and is in contact with the outside air. The surface of the solid object can be visually observed and touched from outside the uneven shape or the solid object. The interior of the solid object is a region that forms an inner side of the uneven shape or the solid object, the region not being in touch with the outside air. If the uneven shape or the solid object is molded from a molding material having high transparency, the interior may be able to be visually observed or touched from outside the uneven shape or the solid object. The first shape slice data and the second shape slice data are generated based on determination results obtained by the determination unit 15 to be described below. The first shape slice data and the second shape slice data are transmitted to the molding material block 30.

Based on the slice data generated by the slice data generation unit 14, the determination unit 15 determines whether each voxel of the slice data is positioned in the interior or on the surface of the solid object. After the determination, the determination unit 15 transmits the slice data obtained by the slice data generation unit 14 and the determination unit 15 and the determination results corresponding to each voxel to the slice data generation unit 14.

The apparatus control unit 12 controls an operation of the entire solid molding apparatus during a molding operation. For example, the apparatus control unit 12 transmits the slice data and the results of the positions of the voxels determined by the determination unit 15 to the molding material block 30. The apparatus control unit 12 transmits mechanism control information for discharging or applying the molding material to a desired position to the head block 20. The mechanism control information is information for performing mechanism control about in what timing to move a head or a molding stage to be described below and to discharge the molding material. Specifically, the mechanism control information is obtained by converting the slice data into three-dimensional coordinates of the solid shape data or the amounts of movement of the head and/or the molding stage, and the moving timing thereof. In other words, the apparatus control unit 12 controls the molding block 30 and the head block 20 in a synchronous manner.

The input unit 11, the apparatus control unit 12, the shape data generation unit 13, the slice data generation unit 14, and the determination unit 15 described above may be configured as pieces of hardware. The input unit 11, the apparatus control unit 12, the shape data generation unit 13, the slice data generation unit 14, and the determination unit 15 may be configured as control programs to function as such. The control programs may be configured to be run on the solid molding apparatus or an apparatus that controls the solid molding apparatus.

<Head Block>

The head block 20 includes a head movement block 21 and a stage movement block 22. The head movement block 21 includes an X direction movement unit 21a and a Y direction movement unit 21b. The stage movement block 22 includes a Z direction movement unit 22a.

The head movement block 21 (X direction movement unit 21a and Y direction movement unit 21b) drives not-illustrated motors and driving mechanisms according to the mechanism control information obtained from the control block 10. The head movement block 21 thereby freely moves a head for discharging or applying the molding material in an X direction (horizontal direction) and a Y direction (horizontal direction).

The stage movement block 22 (Z direction movement unit 22a) drives a not-illustrated motor and driving mechanism according to the mechanism control information obtained from the control block 10. The stage movement block 22 thereby moves the molding stage in a Z direction (downward) or moves the head movement block 21 in the Z direction (upward) to adjust the distance between the head and a molded article.

<Molding Material Block>

The molding material block 30 includes a first supply unit 31, a first molding unit (first molding material discharge unit) 32, a second supply unit 33, and a second molding unit (second molding material discharge unit) 34.

The first supply unit 31 supplies a first molding material stored in a cartridge tank (not illustrated) to the first molding unit 32 (head) through a molding material tube (not illustrated) using a feed pump (not illustrated). The first molding unit 32 discharges the first molding material to a position determined by the head on the molding stage at desired timing according to slice data obtained from the control block 10. The slice data that the first molding unit 32 obtains here is the first shape slice data for molding the interior of the solid object.

Like the first supply unit 31, the second supply unit 33 supplies a second molding material to the second molding unit 34 (head). The second molding unit 34 discharges the second molding material to a position determined by the head on the molding stage according to slice data obtained from the control block 10. The slice data that the second molding unit 34 obtains here is the second shape slice data for molding the surface of the solid object.

The solid molding apparatus may include one or a plurality of first supply units 31, one or a plurality of first molding units 32, one or a plurality of second supply units 33, and one or a plurality of second molding units 34. The first supply unit 31 and the second supply unit 33 may be configured as a common supply unit which supplies the same material to the first molding unit 32 and the second molding unit 34. The first molding unit 32 and the second molding unit 34 may be configured as a common molding unit which changes the molding between first molding and second molding by control of the discharge amount of the molding material to be discharged from the head. For example, a piezoelectric head may be used to change the discharge amount of the molding material for the first molding and for the second molding. A heater 35 may be arranged beside the first molding unit 32 and the second molding unit 34. The purpose of such an arrangement is to heat the molding material(s) in order to reduce the viscosity of the molding material(s) so that the molding material(s) can be easily discharged from the first molding unit 32 and the second molding unit 34. In such a case, the molding material(s) immediately after discharge is/are high in temperature and low in viscosity, and need(s) to be cured by natural cooling or UV irradiation.

<Coloring>

The molding material of the second molding unit 34 may include a coloring material. In such a case, the second molding unit 34 can form fine shapes and simultaneously color the surface of the solid object. If a printing paint for coloring the surface of a molding material is used aside from the molding material, a not-illustrated printing paint supply unit and printing paint coloring unit may further be provided. The printing paint supply unit supplies ink stored in a not-illustrated cartridge tank to the printing paint coloring unit (head) through an ink tube using a feed pump. The printing paint coloring unit is configured integrally with or separate from the first molding unit 32 and the second molding unit 34. Like the first molding unit 32 and the second molding unit 34, the printing paint coloring unit applies the printing paint to the molding material on the molding stage in a position determined by the head at desired timing according to coloring slice data obtained from the control block 10, thereby forming a print image. The solid molding apparatus may include one printing paint supply unit and one printing paint coloring unit. To perform multicolor printing, a plurality of printing paint supply units and a plurality of printing paint coloring units may be included.

If a support material is used aside from the molding material(s), a not-illustrated support material provision unit and support material emission unit may be provided. The support material has a role as a pillar for supporting the molding material(s) when an overhang portion is molded during upward molding. The support material is typically removed by water, heat, or exfoliation after the completion of the molding.

The data provision unit 40 includes a timer that counts a cooling/curing time of the molding material(s) and an irradiation time of the UV lamp 50, a temperature sensor that detects cooling and curing of the molding material(s), a color sensor that detects a color change of the molding material(s) due to curing, and a dosimeter that measures the amount of ultraviolet irradiation by the UV lamp 50. The data provision unit 40 collects information for the apparatus control unit 12 to make a determination whether a stacked new layer of molding material is in a printable state, and provides the information to the apparatus control unit 12.

If an UV cure resin is used as the molding material(s) or an UV cure ink is used as the printing paint, the UV lamp 50 is used to cure such materials.

<Schematic Diagrams of Molding>

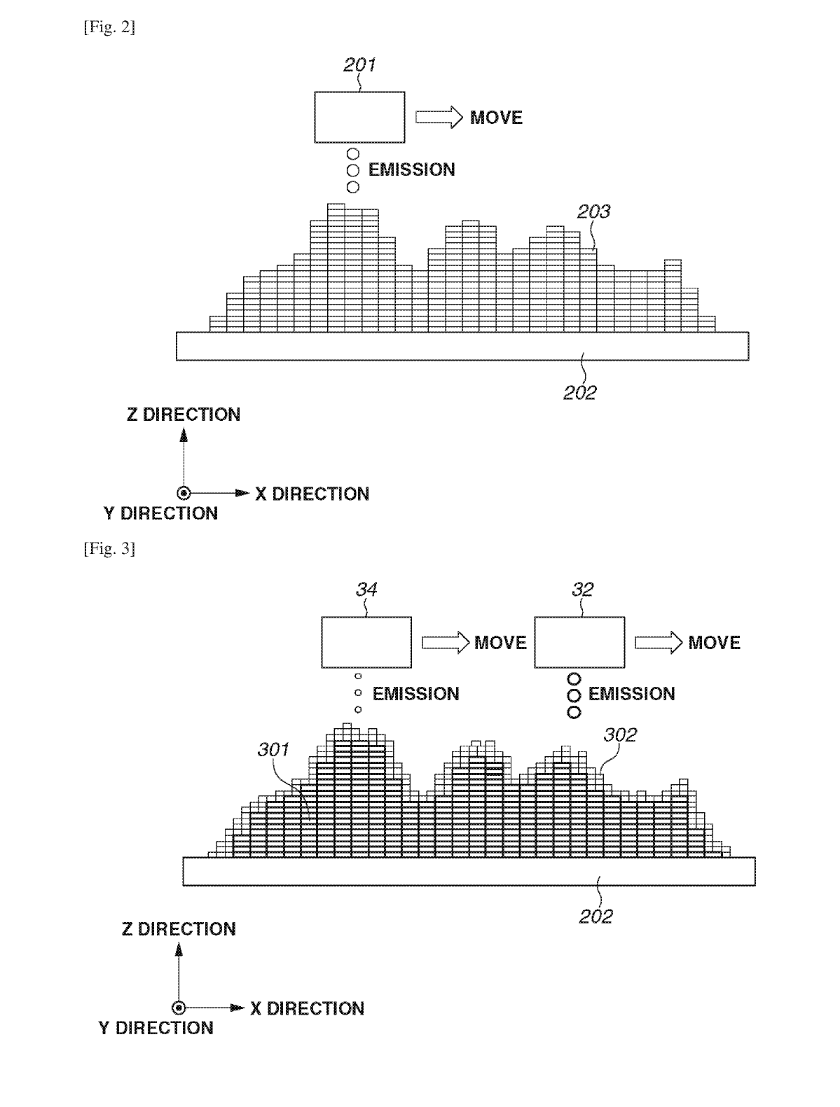

FIG. 2 is a schematic diagram illustrating a state of a cross section in solid molding according to a conventional example. For ease of description, FIG. 2 illustrates a two-dimensional sectional view, illustrating only part of the X direction and the Z direction. The same holds for the following explanatory diagrams. While a molding unit 201 is moved in the X direction and the Y direction in the diagram, a molding material is emitted using a not-illustrated nozzle included in the molding unit 201. The molding unit 201 may include a plurality of nozzles. The molded article is supported by a support 202 during molding. The molding material emitted from the molding unit 201 is formed to be stacked on the molded article as voxels 203 for constituting the molded. article. After the molding material is thus stacked and a layer is molded, the molding unit 201 is lifted up or the molding stage is lowered to perform the molding of the next layer. The layer-by-layer stacking of layers is successively repeated whereby a shape of a solid object can be molded freely.

FIG. 3 is a schematic diagram illustrating a state of solid molding in the first exemplary embodiment. While the first molding unit 32 and the second molding unit 34 are moved in the X direction and the Y direction in the diagram, the respective molding materials are emitted using not-illustrated nozzles included in the first molding unit 32 and the second molding unit 34. The first molding unit 32 and the second molding unit 34 may include a plurality of nozzles. The molded article is supported by the support 202 during molding. Specifically, the molding materials emitted from the first molding unit 32 and the second molding unit 34 are formed to be stacked on the molded article as first voxels 301 (illustrated by thick frames) and second voxels 302 (illustrated by thin frames) for constituting the molded article. First shape slice data is shape data including first voxels 301 for molding a rough shape of the solid object. Second shape slice data is shape data including second voxels 302 for molding fine shapes of the solid object. The first voxels 301 molded by the first molding unit 32 have a size (volume) larger than that of the second voxels 302 molded by the second molding unit 34. The first voxels 301 molded by the first molding unit 32 may have a width greater than that of the second voxels 302 molded by the second molding unit 34. In the diagram, the height (thickness) of the first voxels 301 in the Z direction is illustrated to be the same as that of the second voxels 302 in the Z direction. However, the height (thickness) of the first voxels 301 in the Z direction may be greater than that of the second voxels 302 in the Z direction.

A solid object often has a surface of complicated shape, and it is difficult to exactly define the interior and the surface. In the present exemplary embodiment, the interior and the surface refer to a relative relationship of whether being on the interior side or on the surface side of the solid object. Even in exceptional situations, such as when some of the first voxels 301 are exposed in part of the surface of the solid object, the present exemplary embodiment is applicable if the foregoing relationship holds for most of the solid object. In FIG. 3, with 1 as a unit length, the first voxels 301 are schematically illustrated to have a size (volume), a width in the X direction, a width (not illustrated) in the Y direction, and a height in the Z direction of 72, 6, 6, and 2, respectively. The second voxels 302 are schematically illustrated to have a size (volume), a width in the X direction, a width (not illustrated) in the Y direction, and a height in the Z direction of 18, 3, 3, and 2, respectively. The first voxels 301 and the second voxels 302 are both assumed to be a rectangular parallelepiped. The sizes (volumes), the widths in the X direction, the widths in the Y direction, and the heights in the Z direction of the first voxels 301 and the second voxels 302 may be set to arbitrary sizes, widths, and heights as long as the characteristics of the foregoing magnitude relationship are satisfied.

The first voxels 301 molded by the first molding unit 32 can be molded using a large dot-discharging nozzle or nozzles of an inkjet recording head. The second voxels 302 molded by the second molding unit 34 can be molded using a small dot-discharging nozzle or nozzles of an inkjet recording head. As employed herein, a large dot and a small dot mean that the discharged dots are relatively different in terms of a magnitude relationship at least in one of the size, widths, and height.

After the molding materials are thus stacked and a layer is molded, the first molding unit 32 and the second molding unit 34 are lifted up or the molding stage is lowered to perform the molding of the next layer. The layer-by-layer stacking of layers can be successively repeated whereby a solid object having an arbitrary shape can be molded.

<Molding Order>

The timing to mold the first voxels 301 and the timing to mold the second voxels 302 may have various relationships. All the first voxels 301 may be molded before the second voxels 302 are molded. The first voxels 301 and the second voxels 302 may be molded layer by layer from lower to upper layers. Molding timing to combine the foregoing two methods may be employed. In any of such molding timings, the first voxels 301 are used for molding an interior side of the solid object to be molded. The second voxels 302 are used for molding a surface side of the solid object to be molded.

<Processing Flow>

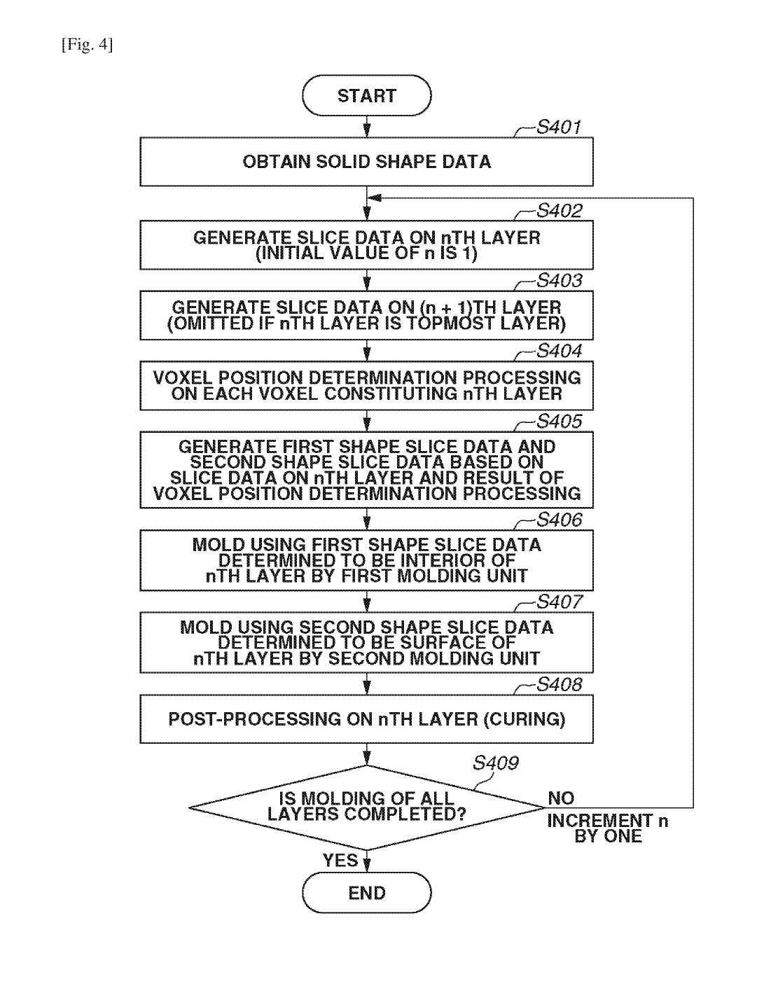

FIG. 4 is a flowchart illustrating a flow of processing (steps) for molding a solid object according to the first exemplary embodiment.

In step S401, the input unit 11 obtains solid shape data (such as CAD data and design data) on an object to be molded from the computer apparatus or the like.

In step S402, the slice data generation unit 14 generates slice data on an nth layer for stacking layers of molding material to mold a solid object based on the solid shape data obtained in step S401. Here, n is the number of pieces of slice data generated. An initial value of n is 1.

In step S403, the slice data generation unit 14 generates slice data on an (n+1)th layer. The slice data on the (n+1)th layer is generated for use in voxel position determination processing in the next step. This step is omitted if the nth layer is the topmost layer.

In step S404, the determination unit 15 performs the voxel position determination processing on each of the voxels constituting the nth layer. The voxel position determination processing is processing for determining whether each voxel of the slice data is positioned in the interior or on the surface of the solid object, based on the slice data generated in steps S402 and S403. The determination unit 15 checks whether there is a plurality of voxels to be molded around the voxel to be determined. If there is a missing voxel around the voxel to be determined, the determination unit 15 determines that the voxel to be determined is on the surface. If there are voxels all around the voxel to be determined, the determination unit 15 determines that the voxel to be determined is in the interior. For example, a top, bottom, right, left, front, and back, a total of six voxels can be defined as the ones around the voxel to be determined. In such a case, in step S403, the determination unit 15 generates and stores slice data on an (n−1)th layer in addition to that on the (n+1)th layer. Considering diagonal directions with respect to the voxel to be determined, for example, a total of 26 (3×3×3−1) surrounding voxels may be defined as the ones around the voxel to be determined.

In step S405, the slice data generation unit 14 generates first shape slice data and second shape slice data based on the slice data on the nth layer and the result of the voxel position determination processing. The first shape slice data includes a plurality of first voxels 501. The second shape slice data includes a plurality of second voxels 502. The first voxels 501 and the second voxels 502 will be described below.

In step S406, the molding material block 30 causes the first molding unit 32 to mold the first voxels 501 using the first shape slice data determined to be the interior of the nth layer. In step S407, the molding material block 30 causes the second molding unit 34 to mold the second voxels 502 using the second shape slice data determined to be the surface of the nth layer.

In step S408, the apparatus control unit 12 performs post-processing on the nth layer. In the present exemplary embodiment, the apparatus control unit 12 performs ultraviolet irradiation using the UV lamp 50 to cure the article molded by the first molding unit 32 and the second molding unit 34.

In step S409, the apparatus control unit 12 determines whether the molding of all the layers is completed. If the molding of all the layers is completed (YES in step S409), the molding processing ends. If the molding of all the layers is not completed (NO in step S409), the apparatus control unit 12 increments n by one, and the processing returns to step S402 and the next layer is molded in a similar manner. If the control block 10 is configured as a data generation apparatus, the processing of steps S406 to S408 is skipped. In step S409, the apparatus control unit 12 then determines whether the first shape slice data and the second shape slice data on all the layers have been generated, instead of determining whether the molding of all the layers is completed.

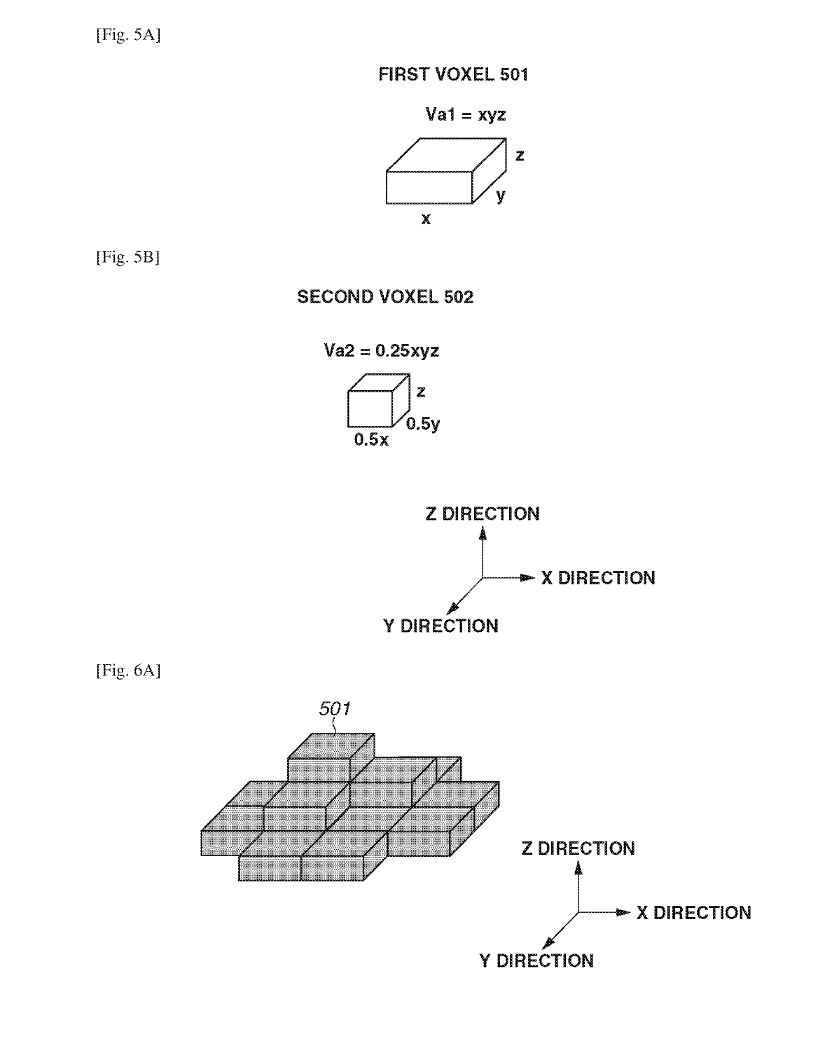

FIGS. 5A and 5B are schematic diagrams illustrating first and second voxels according to the first exemplary embodiment. FIG. 5A illustrates a first voxel 501. The first voxel 501 is molded by the first molding unit 32. The first voxel 501 is expressed. as voxel data that is represented by a rectangular parallelepiped having a width of x, a width of y, and a height of z with respect to the three-dimensional axes of the X, Y, and Z directions. The first voxel 501 has a size (volume) of Vb1 which is xyz. FIG. 5B illustrates a second voxel 502. The second voxel 502 is molded by the second molding unit 34. The second voxel 502 is expressed as voxel data that is represented by a rectangular parallelepiped having a width of 0.5x, a width of 0.5y, and a height of z with respect to the three-dimensional axes of the X, Y, and Z directions. The second voxel 502 has a size (volume) of Vb2 which is 0.25xyz. If the molding method is an inkjet method, the first voxel 501 and the second voxel 502 can be formed, for example, with x and y of 40 μm and z of 10 μm. As can be seen from a comparison between FIGS. 5A and 5B, the size of the voxel 501 molded by the first molding unit 32 is larger than that of the voxel 502 molded by the second molding unit 34. The widths x and y of the first voxel 501 molded by the first molding unit 32 are greater than those of the second voxel 502 molded by the second molding unit 34.

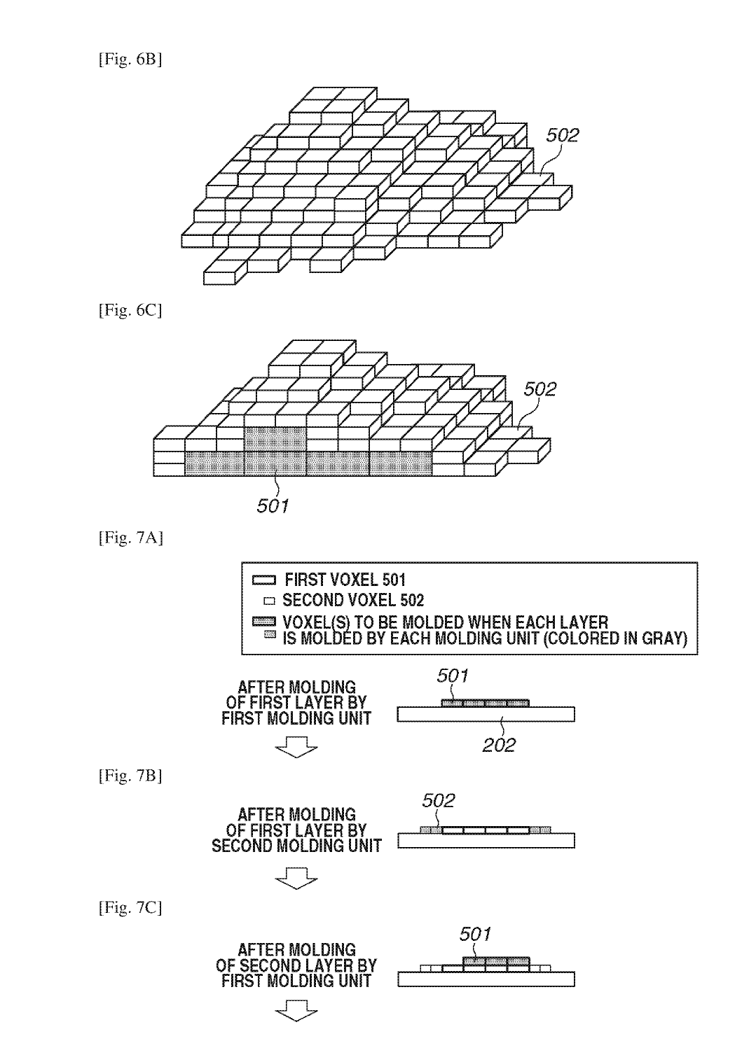

FIGS. 6A to 6C are schematic diagrams three-dimensionally illustrating a solid object, which is molded in the first exemplary embodiment. For ease of description, the schematic diagrams illustrate the solid object including, at most, just over a dozen voxels in each of the X, Y, and Z directions. Actual solid objects are molded by using greater numbers of voxels according to the sizes of the solid objects. FIG. 6A is a schematic diagram three-dimensionally illustrating a solid object including only first voxels 501 molded by the first molding unit 32. FIG. 6B is a schematic diagram three-dimensionally illustrating a solid object obtained by further molding second voxels 502 by the second molding unit 34 onto the solid object including the first voxels 501 of FIG. 6A. Although not seen in FIG. 6B, there are the first voxels 501 inside the solid object of FIG. 6B. FIG. 6C is a schematic diagram three-dimensionally illustrating a cross section of the solid object of FIG. 6B. The interior of the solid object in FIG. 6C is composed of the first voxels 501. The surface of the solid object in FIG. 6C is composed of the second voxels 502. In the present exemplary embodiment, the interior and the surface of the solid object are thus molded using the first voxel 501 and the second voxel 502 each having a different size. To clarify the distinction between the interior and the surface of the solid object, FIGS. 6A to 6C illustrate the first voxels 501 in gray and the second voxels 502 in white. Such coloring is simply for convenience of description, and does not represent the color of the molding materials or the characteristics of the materials.

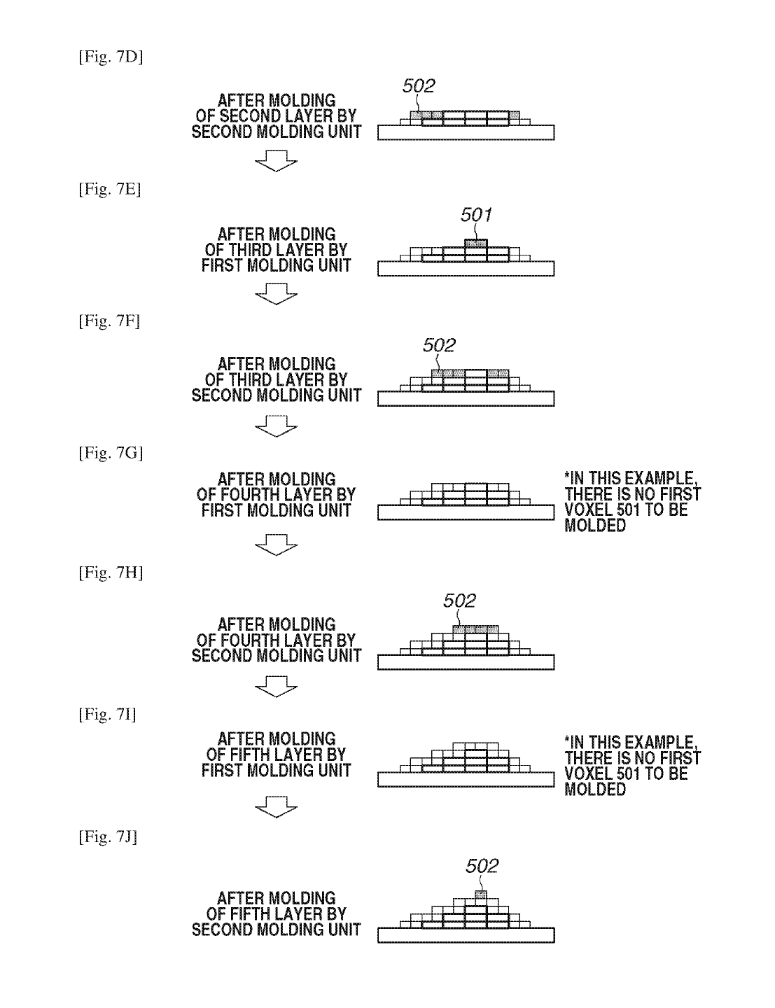

FIGS. 7A to 7J are schematic diagrams illustrating cross sections of a solid object in the process of molding the solid object according to the first exemplary embodiment. The layers are molded in succession by the first molding unit 32 and the second molding unit 34 from FIG. 7A to FIG. 7J so that the solid object is molded. For convenience of description, in each of FIGS. 7A to 7J, first voxels 501 are illustrated in thick frames, and second voxels 502 in thin frames. In each of the processes of FIGS. 7A to 7J, the first voxels 501 molded by the first molding unit 32 or the second voxels 502 molded by the second molding unit 34 are illustrated in gray. The processes will be described in order. FIG. 7A is a schematic diagram illustrating a molded article after the molding of a first layer by the first molding unit 32. In this process, the first molding unit 32 molds the first voxels 501 on the support 202. FIG. 7B is a schematic diagram illustrating the molded article after the molding of the first layer by the second molding unit 34. In this process, the second molding unit 34 molds the second voxels 502 on the support 202. FIG. 7C is a schematic diagram illustrating the molded article after the molding of a second layer by the first molding unit 32. In this process, the first molding unit 32 molds the first voxels 501 on the molded layer. FIG. 7D is a schematic diagram illustrating the molded article after the molding of the second layer by the second molding unit 32. In this process, the second molding unit 34 molds the second voxels 502 on the molded layer. In FIGS. 7E to 7J, like in FIGS. 7C and 7D, the first molding unit 32 or the second molding unit 34 is used to mold first voxels 501 or second voxels 502 on the molded layers, whereby a final solid object is molded. The processes of FIGS. 7G and 7I are omitted because there is no first voxel 501 to be molded.

In the present exemplary embodiment, in order for the article currently molded to be cured, ultraviolet irradiation is performed using the UV lamp 50 after each process. Process conditions including the amount of ultraviolet rays, irradiation time, and an interval from molding to irradiation can be arbitrarily controlled so that the molding materials are appropriately cured.

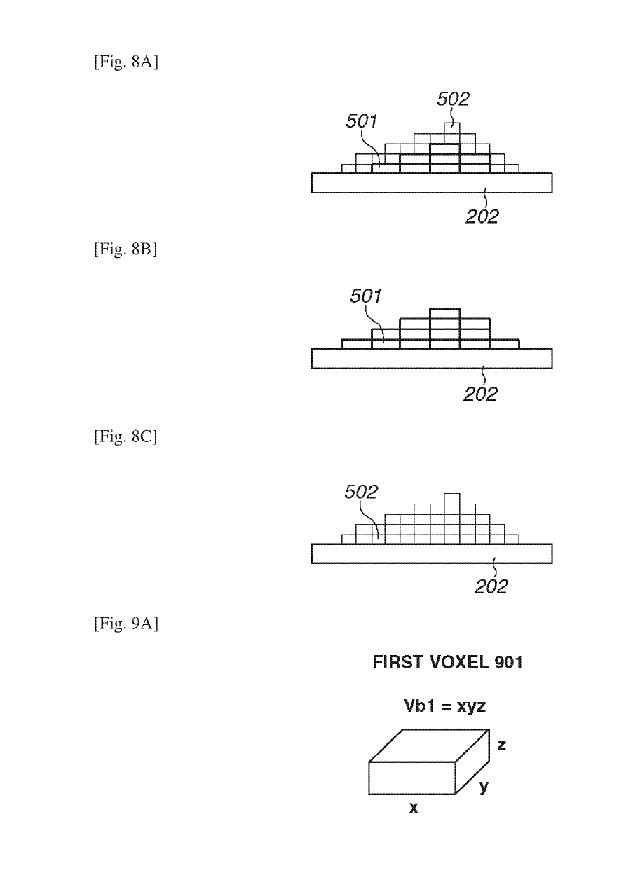

FIGS. 8A to 8C are schematic diagrams illustrating differences between a cross section of the solid object according to the first exemplary embodiment and cross sections of solid objects according to conventional examples. FIG. 8A illustrates an example of a cross section of the solid object molded in the first exemplary embodiment. FIGS. 8B and 8C illustrate conventional solid objects. FIG. 8B illustrates an example of a cross section of a solid object molded using only first voxels 501. FIG. 8C illustrates an example of a cross section of a solid object molded using only second. voxels 502.

The solid object in FIG. 8B is molded using only the first voxels 501 of larger size. As compared to the solid object in FIG. 8C which is molded using only the second voxels 502 of smaller size, the number of voxels to be molded in the solid object in FIG. 8B is less than the number of voxels to be molded in the solid object in FIG. 8C. The solid object in FIG. 8B therefore can be molded at higher speed. However, since the solid object of FIG. 8B is molded using only the first voxels 501 of larger size, the size of the molded voxels in FIG. 8B is greater than the size of the molded voxels in FIG. 8C where the solid object is molded using only the second voxels 502 of smaller size. Consequently, the solid object in FIG. 8B has a rougher surface shape and lower molding precision.

As described in the first exemplary embodiment above, the conventional molding method like FIGS. 8B and 8C has the problem that there is a trade-off between the molding precision and molding time of a solid object. Such a problem can be solved by performing molding like FIG. 8A. More specifically, a rough shape corresponding to the interior of a solid object is molded at high speed using first voxels 501 of larger size. Fine shapes on the surface of the solid object are molded with high definition using second voxels 502 of smaller size. The solid object can thus be molded with high definition at high speed.

### Second Exemplary Embodiment

In the first exemplary embodiment, a method for molding a solid object using first voxels 501 and second voxels 502 having different sizes (volumes), different widths in the X and Y directions, and the same height in the Z direction has been described. In a second exemplary embodiment, a method for molding a solid object using first voxels and second voxels having different sizes (volumes), different widths in the X and Y directions, and different heights in the Z direction will be described.

In the second exemplary embodiment, first voxels and second voxels have different heights in the stacking direction of layers. According to such a height relationship, the number of layers including second voxels molded by the second molding unit 34 is different from the number of layers including first voxels molded by the first molding unit 32. In the second exemplary embodiment, a description of similar parts to those of the first exemplary embodiment will be omitted, and differences will be mainly described.

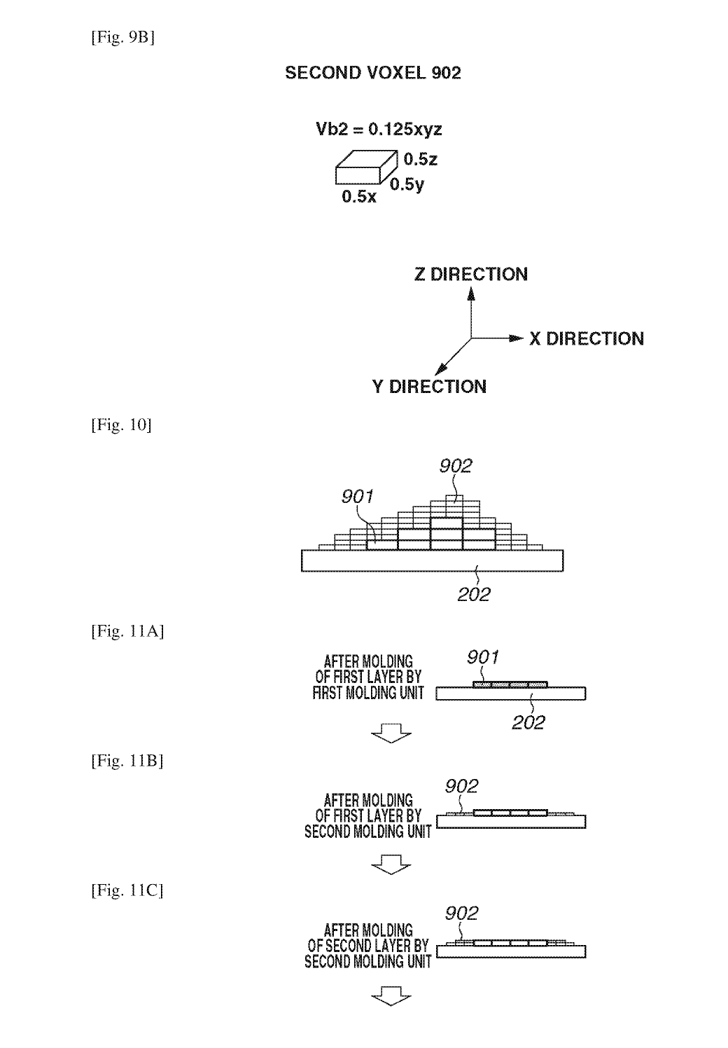

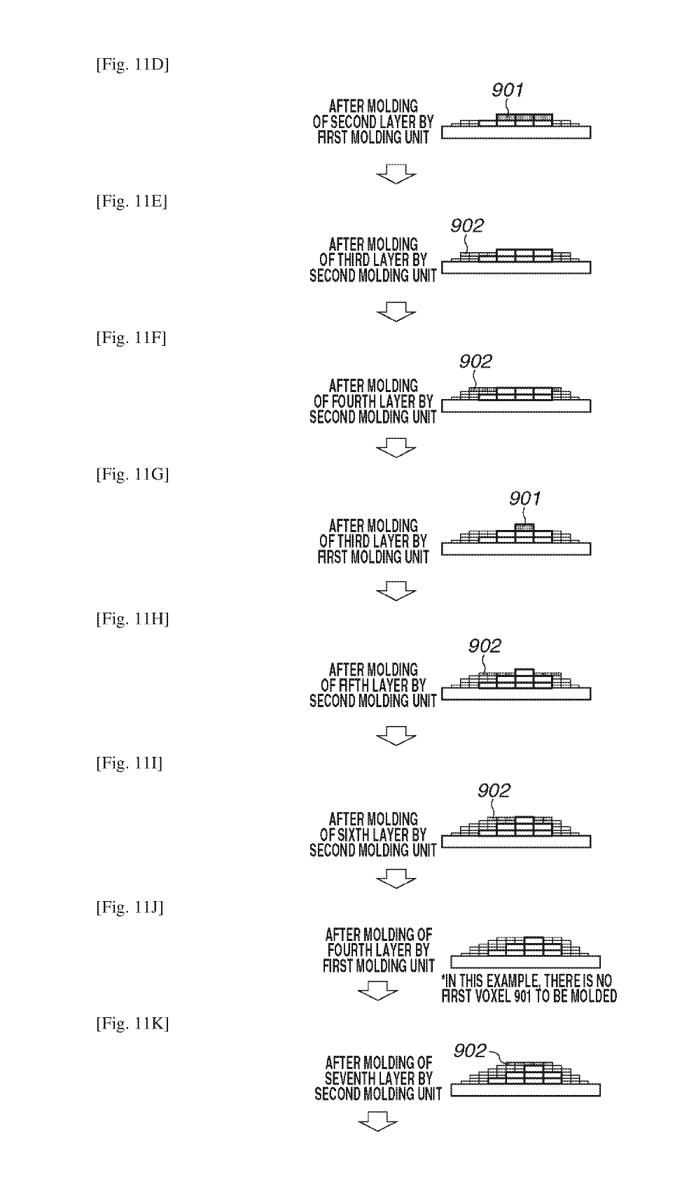

FIGS. 9A and 9B are schematic diagrams illustrating a first voxel and a second voxel according to the second exemplary embodiment. FIG. 9A illustrates a first voxel 901. The first voxel 901 is molded by the first molding unit 32. The first voxel 901 is expressed as voxel data that is represented by a rectangular parallelepiped having a width of x, a width of y, and a height of z with respect to the three-dimensional axes of the X, Y, and Z directions. The first voxel 901 has a size (volume) of Vb1 which is xyz. FIG. 9B illustrates a second voxel 902. The second voxel 902 is molded by the second molding unit 34. The second voxel 902 is expressed as voxel data that is represented by a rectangular parallelepiped having a width of 0.5x, a width of 0.5y, and a height of 0.5z with respect to the three-dimensional axes of the X, Y, and Z directions. The second voxel 902 has a size (volume) of Vb2 which is 0.125xyz. If the molding method is an inkjet method, the first voxel 901 and the second voxel 902 can be formed, for example, with x and y of 40 μm and z of 10 μm. As can be seen from a comparison between FIGS. 9A and 9B, the size, widths, and height of the first voxel 901 molded by the first molding unit 32 are greater than those of the second voxel 902 molded by the second molding unit 34.

FIG. 10 is a schematic diagram illustrating a cross section of a solid object according to the second exemplary embodiment. In the second exemplary embodiment, like the first exemplary embodiment, the interior of the solid object is molded by using first voxels 901 of larger size. The surface of the solid object is molded using second voxels 902 of smaller size. Since the first voxels 901 and the second voxels 902 have different heights, the required number of the second voxels 902 of smaller height to be stacked in layers is more than the number of the first voxels 901 of greater height for molding a three-dimensional object. In other words, the number of layers of second voxels 902 to be molded is greater than the number of layers of first voxels 901 to be molded. In an example of the second exemplary embodiment, as described above, the first voxels 901 have a height of z and the second voxels 902 have a height of 0.5z. Due to such a relationship, the number of layers of second voxels 902 to be molded is twice the number of layers of first voxels 901 to be molded. The numbers of layers of first voxels 901 and second voxels 902 to be molded can be arbitrarily determined according to the relationship between the heights of the first voxels 901 and the second voxels 902.

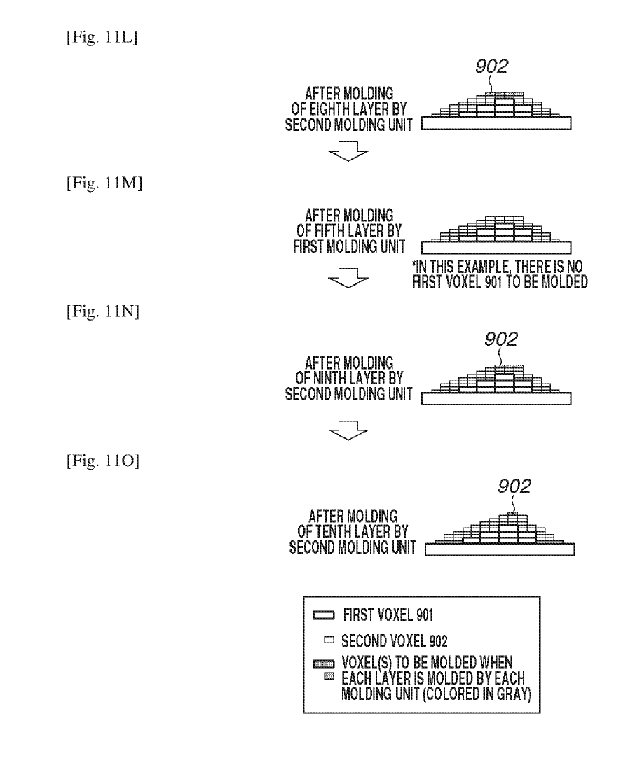

FIGS. 11A to 110 are schematic diagrams illustrating cross sections of a solid object in the process of molding the solid object according to the second exemplary embodiment. The layers are molded in succession by the first molding unit 32 and the second molding unit 34 from FIG. 11A to FIG. 110 so that the solid object is molded. For convenience of description, in each of FIGS. 11A to 11O, the first voxels 901 are illustrated in thick frames, and the second voxels 902 are illustrated in thin frames. The first voxels 901 and the second voxels 902 molded in each of the processes of FIGS. 11A to 11O by the first molding unit 32 and the second molding unit 34, respectively, are illustrated in gray. The processes will be described in order.

FIG. 11A is a schematic diagram illustrating a molded article after the molding of a first layer by the first molding unit 32. In this process, the first molding unit 32 molds the first voxels 901 on the support 202. FIG. 11B is a schematic diagram illustrating the molded article after the molding of a first layer by the second molding unit 34. In this process, the second molding unit 34 molds the second voxels 902 on the support 202. FIG. 11C is a schematic diagram illustrating the molded article after the molding of a second layer by the second molding unit 34. In this process, the second molding unit 34 molds the second voxels 902 on the molded layer. FIG. 11D is a schematic diagram illustrating the molded article after the molding of a second layer by the first molding unit 32. In this process, the first molding unit 32 molds the first voxels 901 on the molded layer. FIG. 11E is a schematic diagram illustrating the molded article after the molding of a third layer by the second molding unit 34. In this process, the second molding unit 34 molds the second voxels 902 on the molded layers. FIG. 11F is a schematic diagram illustrating the molded article after the molding of a fourth layer by the second molding unit 34. In this process, the second molding unit 34 molds the second voxels 902 on the molded layers. In FIGS. 11G to 11O, like FIGS. 11D and 11F, the first molding unit 32 and the second molding unit 34 are used for molding first voxels 901 and second voxels 902, respectively, on the molded layers, whereby a final solid object is molded. The processes of FIGS. 11J and 11M are omitted because there is no first voxel 901 to be molded.

In the second exemplary embodiment, like the first exemplary embodiment, in order for the currently molded article to be cured, ultraviolet irradiation is performed using the UV lamp 50 after each process. Process conditions including the amount of ultraviolet rays, the irradiation time, and the interval from molding to irradiation can be arbitrarily controlled so that the molding materials are appropriately cured.

As described in the second exemplary embodiment above, a rough shape corresponding to the interior of a solid object is molded at high speed using first voxels 901 of larger size. Fine shapes on the surface of the solid object are molded with high definition using second voxels 902 of smaller size. The solid object can thus be molded at high speed and with high definition.

### Third Exemplary Embodiment

In the first and second exemplary embodiments, an example of generating first shape slice data and second shape slice data by generating slice data from solid shape data and determining whether each voxel constituting the slice data is positioned in the interior or on the surface of the solid object has been described.

A third exemplary embodiment describes an example of taking the frequency of solid shape data into consideration to generate shape data having a first frequency band and shape data having a second frequency band, and generating slice data from such shape data. A description of similar parts to those of the first exemplary embodiment or the second exemplary embodiment will be omitted, and differences will be mainly described below.

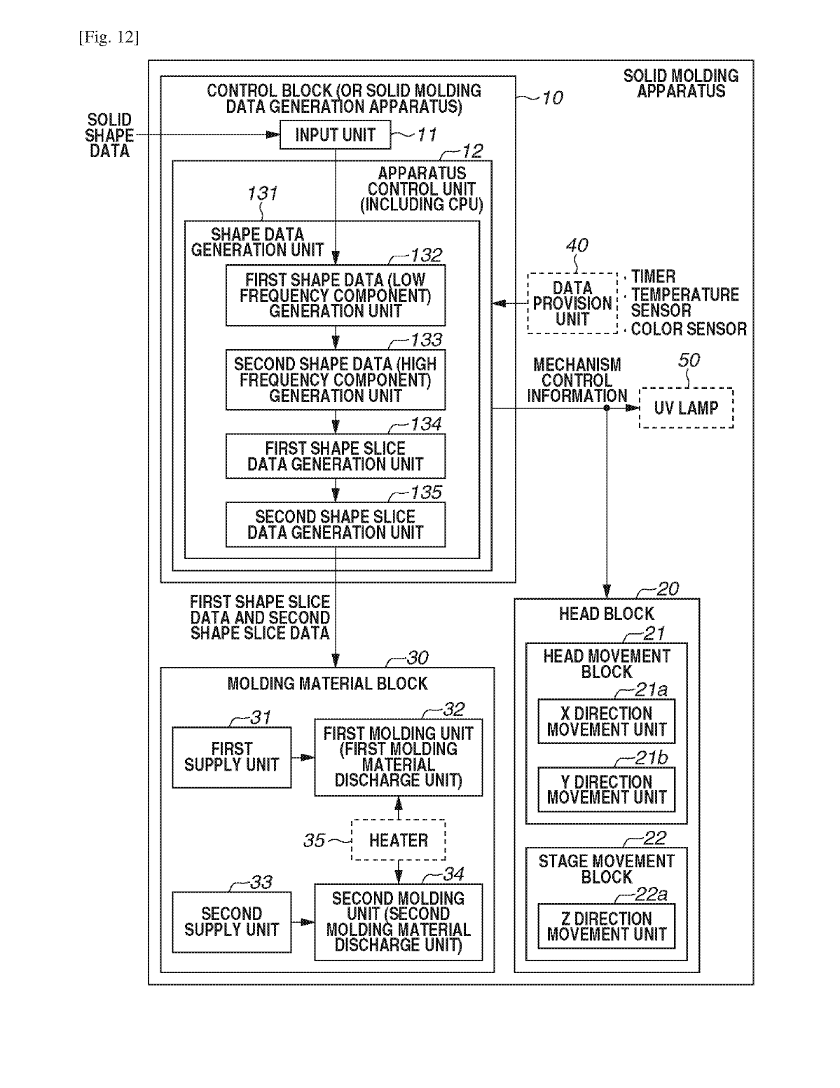

FIG. 12 is a block diagram illustrating a configuration of a solid molding apparatus according to the third exemplary embodiment. In this block diagram, the shape data generation unit 13 of FIG. 4 is replaced with a shape data generation unit 131. The configuration of the solid molding apparatus other than the shape data generation unit 131 is thus the same as that of FIG. 4. The shape data generation unit 131 will be described below.

The shape data generation unit 131 includes a first shape data generation unit 132, a second shape data generation unit 133, a first shape slice data generation unit 134, and a second shape slice data generation unit 135.

Based on the input solid shape data, the first shape data generation unit 132 generates first shape data such that a solid shape expressed by the solid shape data has a first frequency band. The first shape data is shape data corresponding to low frequency components of the solid shape data.

Based on the input solid shape data, the second shape data generation unit 133 generates second shape data such that a solid shape expressed by the solid shape data has a second frequency band. The second shape data is shape data corresponding to high frequency components of the solid shape data. The sum of the first shape data and the second shape data is the solid shape data.

The first shape slice data generation unit 134 slices the first shape data in the stacking direction of layers of molding material to generate first shape slice data. The first shape slice data includes first voxels 901 for molding the interior of the solid object.

The second shape slice data generation unit 135 slices the second shape data in the stacking direction of layers of molding material to generate second shape slice data.

The second shape slice data includes second voxels 902 for molding the surface of the solid object.

The first shape slice data and the second shape slice data are transmitted to the molding material block 30.

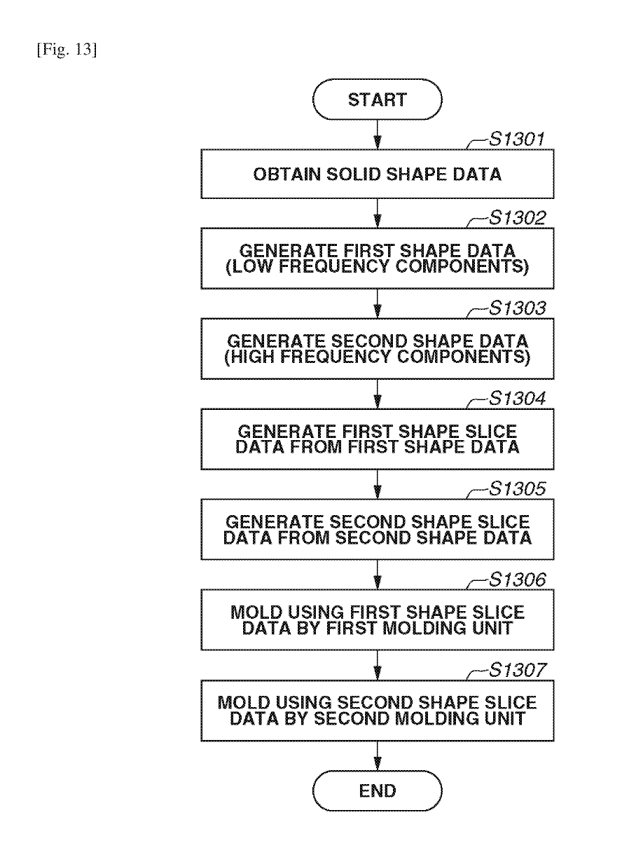

FIG. 13 is a flowchart illustrating a method for molding the solid object according to the third exemplary embodiment.

In step S1301, solid shape data is input. In this step, the input unit 11 obtains solid shape data (such as CAD data and design data) on an object to be molded from a computer apparatus.

In step S1302, the first shape data generation unit 132 generates first shape data having the first frequency band based on the input solid shape data. The first shape data is lower in frequency than the solid shape data.

In step S1303, the second shape data generation unit 133 generates second shape data having the second frequency band based on the input solid shape data. In the present exemplary embodiment, the second shape data is the same as the solid shape data. The second shape data may be made different from the solid shape data by processing, for example, in which the precision of the second shape data is set lower than that of the solid shape data in consideration of the size of voxels that are to be used in molding for the second shape data.

In step S1304, the first shape slice data generation unit 134 slices the first shape data generated in step S1302 in the stacking direction of layers of molding material to generate first shape slice data. The first shape slice data includes first voxels 901 for molding the interior of the solid object.

In step S1305, the second shape slice data generation unit 135 slices the second shape data generated in step S1303 in the stacking direction of layers of molding material to generate second shape slice data. The second shape slice data includes second voxels 902 for molding the surface of the solid object.

In step S1306, the first molding unit 32 performs molding using the first shape slice data (first molding). Like the first and second exemplary embodiments, the first molding unit 32 molds the first voxels 901.

In step S1307, the second molding unit 34 performs molding using the second shape slice data (second molding). Like the first and second exemplary embodiments, the second molding unit 34 molds the second voxels 902.

In the first molding in step S1306 and the second molding in step S1307, in order for the molded article to be cured, the apparatus control unit 12 performs ultraviolet irradiation using the UV lamp 50.

In the processing flow described above, after the molding by the first molding unit 32 using the first shape slice data, the second shape slice data is used for the molding. However, the molding by the first molding unit 32 and the molding by the second molding unit 34 may be both performed from lower to upper layers to mold the solid object.

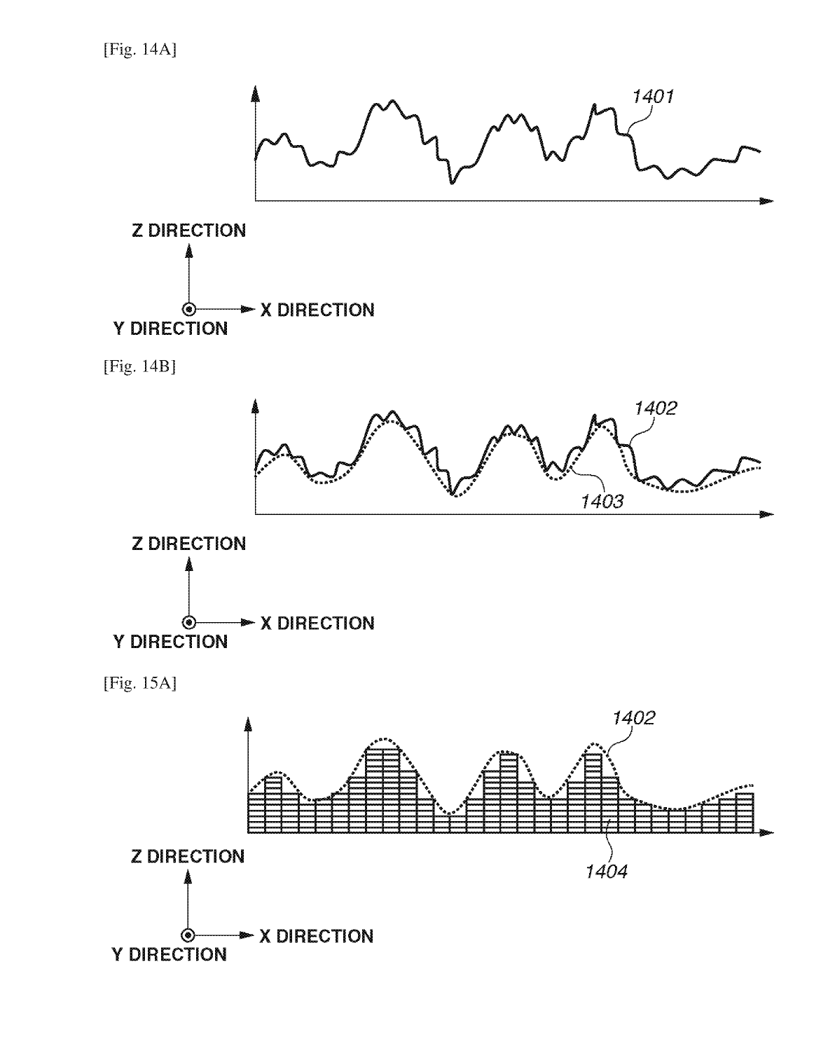

FIGS. 14A and 14B are schematic diagrams illustrating a method for generating the first shape data and the second shape data based on the solid shape data according to the third exemplary embodiment. FIG. 14A illustrates solid shape data 1401. For the sake of simplicity, a two-dimensional cross section of the solid shape data 1401 in the X and Z directions is schematically illustrated by a continuous line. In fact, the solid shape data 1401 is data expressing a solid shape in the XYZ three-dimensional space. FIG. 14B schematically illustrates two-dimensional cross sections in the X and Z directions of first shape data 1402 and second shape data 1403 generated based on the solid shape data 1401 of FIG. 14A. As described in steps S1301 and S1302, the first shape data 1402 is lower in frequency than the solid shape data 1401 and the second shape data 1403.

The solid shape data 1401, the first shape data 1402, and the second shape data 1403 each can be expressed by a data format in which, for example, a solid shape is expressed as an aggregate of small triangles. In generating the first shape data 1402 and the second shape data 1403 from the solid shape data 1401, various types of conventional filter processing and signal processing, such as a three-dimensional low-pass filter, three-dimensional Fourier transform, and convex hull, are applied to the original solid shape data 1401. For example, in the case of a low-pass filter, a filter having a filter size of 3×3×3 and an efficient of 1 is applied. In such a manner, desired shape data, such as illustrated in FIG. 14B can be generated.

If the shape of the first shape data 1402 generated by the foregoing various methods exceeds the shape of the solid shape data 1401 to the surface, the first shape data 1402 can be appropriately clipped so that the shape of the first shape data 1402 arranged within the interior of the shape of the solid shape data 1401.

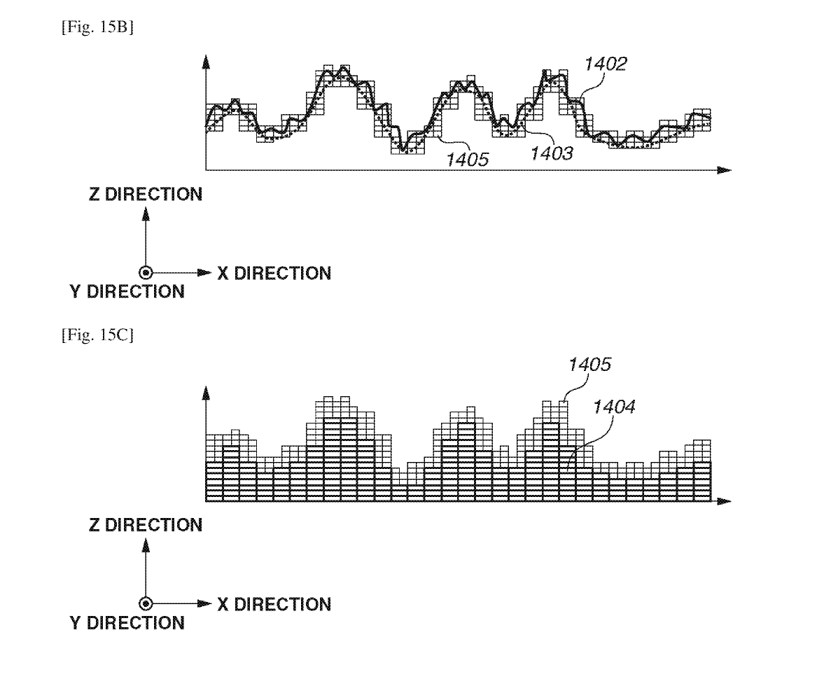

FIGS. 15A to 15C are schematic diagrams illustrating a method for generating the first shape slice data and the second shape slice data according to the third exemplary embodiment. FIG. 15A schematically illustrates first voxels 1404 of when first shape slice data is generated based on the first shape data 1402. Like FIGS. 14A and 14B, for the sake of simplicity, a two-dimensional cross section of the slice data in the X and Z directions is schematically illustrated by a continuous line. In fact, the slice data is data expressing a solid shape in the XYZ three-dimensional space. The first shape slice data is generated such that the first voxels 1404 are arranged within the interior side of the shape of the first shape data 1402. FIG. 15B schematically illustrates second voxels 1405 generated based on the first shape data 1402 and the second shape data 1403. The second voxels 1405 are generated such that the second voxels 1405 are in positions to fill the space between the first shape data 1402 and the second shape data 1403. FIG. 15C schematically illustrates the first voxels 1404 and the second voxels 1405 generated. The second voxels 1405 are positioned in contact with the first voxels 1404 and to form the outer side of the solid object.

As described in the third exemplary embodiment above, the frequency of the solid shape data is taken into consideration to generate shape data having the first frequency band and shape data having the second frequency band, and to generate respective pieces of slice data. The shape data having the first frequency band of lower frequencies is used for high speed molding using first voxels 1404 of larger size. The shape data having the second frequency band of higher frequencies is used for high definition molding using second voxels 1405 of smaller size. The solid object can thus be molded at high speed and with high precision.

### Fourth Exemplary Embodiment

In the third exemplary embodiment, an example of molding using the shape data having the first frequency band of lower frequencies at high speed by using first voxels 1404 of larger size and molding using the shape data having the second frequency band of higher frequencies with high definition by using second voxels 1405 of smaller size has been described. A fourth exemplary embodiment describes an example in which the shape data having the first frequency band of lower frequencies is used for molding at high speed by using first voxels of larger size, and then the shape of the resulting first molded article is measured by a shape-measuring sensor to determine a differential shape from the solid shape data. The differential shape is molded with high precision using second voxels of smaller size. A description of a configuration and method similar to those of the third exemplary embodiment will be omitted, and differences will be mainly described below.

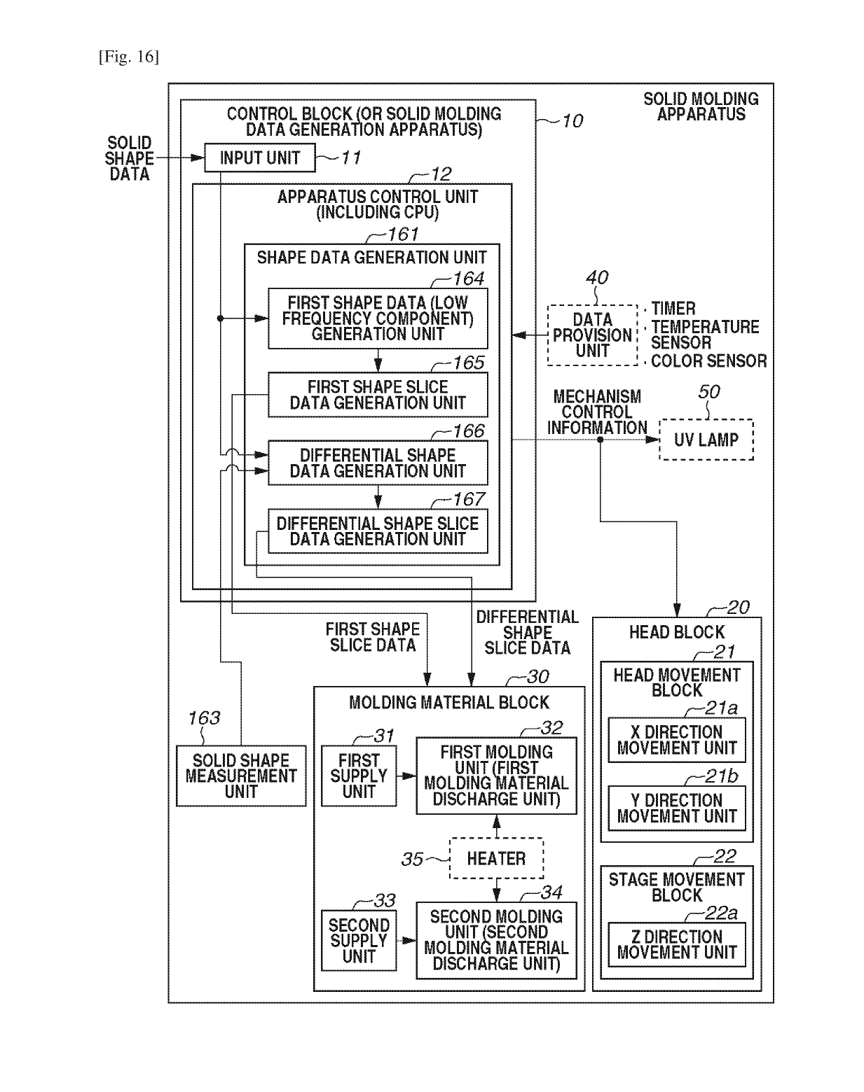

FIG. 16 is a block diagram illustrating a configuration of a solid molding apparatus according to the fourth exemplary embodiment. This block diagram is obtained by replacing the shape data generation unit 131 of FIG. 12 with a shape data generation unit 161, and newly adding a solid shape measurement unit 163. The shape data generation unit 161 includes a first shape data (low frequency component) generation unit 164, a first shape slice data generation unit 165, a differential shape data generation unit 166, and a differential shape slice data generation unit 167. The rest of the configuration is the same as in the third exemplary embodiment.

The first shape data generation unit 164 generates first shape data having the first frequency band based on input solid shape data. The first shape data is shape data corresponding to low frequency components of the solid shape data.

The first shape slice data generation unit 165 slices the first shape data in the stacking direction of layers of molding material to generate first shape slice data. The first shape slice data includes first voxels for molding the interior of the solid object. The first shape slice data is transmitted to the molding material block 30 and molded by the first molding unit 32.

The solid shape measurement unit 163 measures the shape of the solid object molded by the first molding unit 32, and transmits the measurement result to the differential shape data generation unit 166.

Based on the solid shape data and the measurement result measured by the solid shape measurement unit 163, the differential shape data generation unit 166 generates differential shape data as differential data between the solid shape data and the measurement result.

Based on the differential shape data, the differential shape slice data generation unit 167 slices the differential shape data in the stacking direction of layers of molding material to generate differential shape slice data. The differential shape slice data includes second voxels for forming differences from the solid object. The differential shape slice data is transmitted to the molding material block 30 and used for molding by the second molding unit 34.

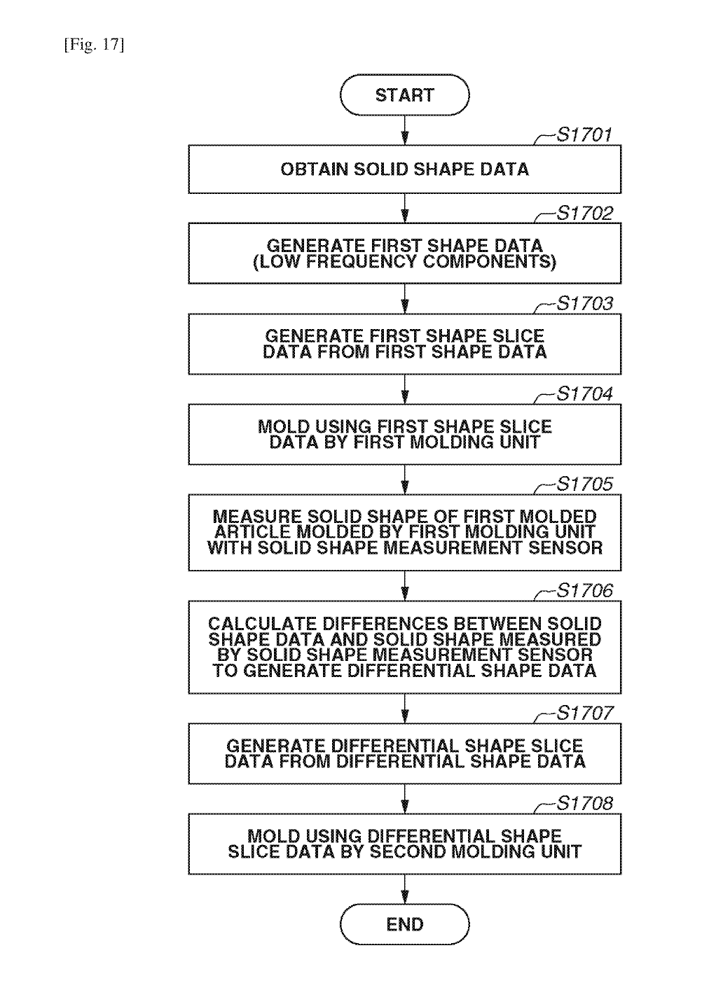

FIG. 17 is a flowchart illustrating a method for molding a solid object according to the fourth exemplary embodiment.

In step S1701, solid shape data is input. In this step, the input unit 11 obtains solid shape data (such as CAD data and design data) on an object to be molded from a computer apparatus.

In step S1702, the first shape data generation unit 164 generates first shape data having the first frequency band based on the input solid shape data. The first shape data is lower in frequency than the solid shape data.

In step S1703, the first shape slice data generation unit 165 slices the first shape data generated in step S1702 in the stacking direction of layers of molding material to generate first shape slice data. The first shape slice data includes first voxels for forming the interior of the solid object.

In step S1704, the first molding unit 32 performs molding using the first shape slice data. Like the first to third exemplary embodiments, the first molding unit 32 molds the first voxels.

In step S1705, the solid shape measurement unit 163 (solid shape measurement sensor) measures the solid shape of the first molded article molded by the first molding unit 32. Examples of the solid shape measurement sensor include a three-dimensional scanner (three-dimensional digitizer) for optically measures the shape of a solid object in a non-contact manner, and a contact type shape measurement sensor. Various other methods may be used to measure the solid shape as long as the solid shape of the first molded article molded by the first molding unit 32 can be measured.

In step S1706, the differential shape data generation unit 166 calculates differences between the solid shape data and the solid shape measured by the solid shape measurement sensor to generate differential shape data.

In step S1707, the differential shape slice data generation unit 167 generates differential shape slice data from the differential shape data.

In step S1708, the second molding unit 34 performs molding using the differential shape slice data. Like the first to third exemplary embodiments, the second molding unit 34 molds the second voxels.

In the first molding in step S1704 and the second molding in step S1708, in order for the molded article to be cured, the apparatus control unit 12 performs ultraviolet irradiation using the UV lamp 50.

As described in the fourth exemplary embodiment above, the frequency of the solid shape data is taken into consideration and the shape data having the first frequency band is used for the molding by the first molding unit 32. The shape of the molded article is then measured, and differences between the measurement result and the solid. shape data indicating the solid object to be molded are determined and the second molding unit 34 performs molding. The solid object can thus be molded at high speed and with high definition.

### Fifth Exemplary Embodiment

In the fourth exemplary embodiment, an example where after the molding by the first molding unit 32 using the first shape data generated from the solid shape data, the shape of the molded article is measured and the second molding unit 34 performs molding using differential shape data on differences between the measured molded article and the original solid shape data has been described. A fifth exemplary embodiment describes an example in which the shape of the molded article is not measured, but differences between the original solid shape data and the first shape slice data obtained by slicing the first shape data are calculated and the second molding unit 34 performs molding based on the calculated differential shape data. A description of similar parts to those of the fourth exemplary embodiment will be omitted, and differences will be mainly described below.

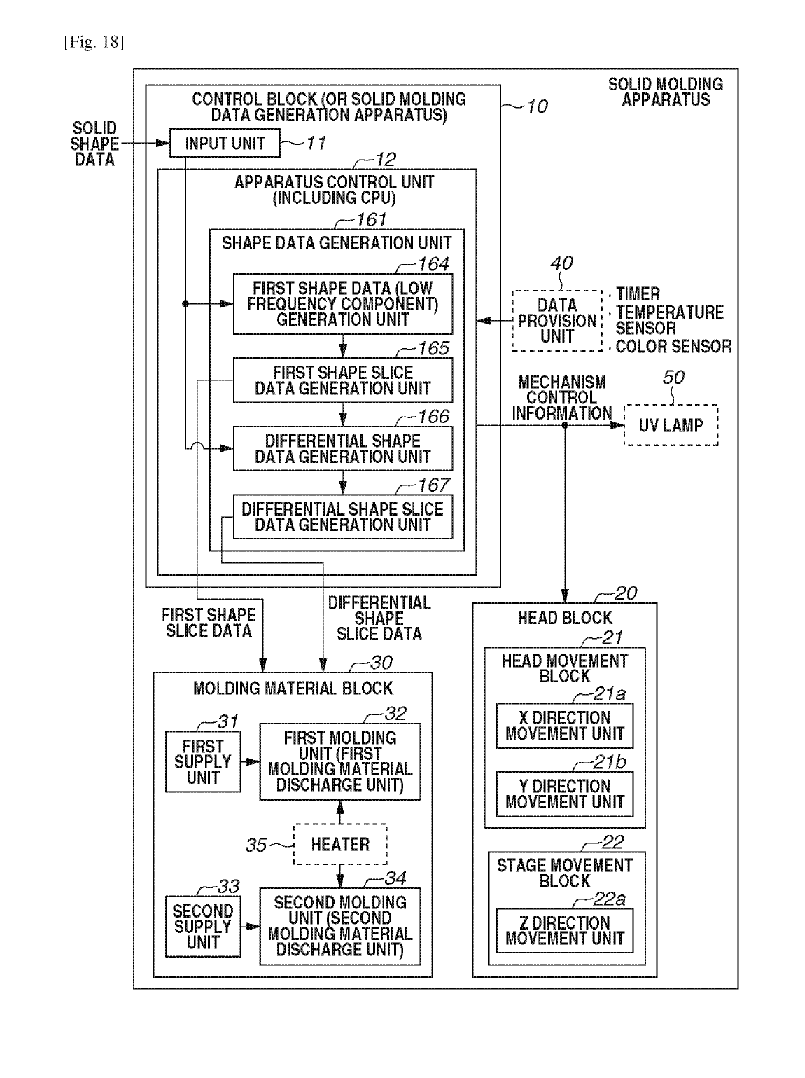

FIG. 18 is a block diagram illustrating a configuration of a solid molding apparatus according to the fifth exemplary embodiment. This block diagram is obtained by removing the solid shape measurement unit 163 and its connection to the differential shape data generation unit 166 according to the fourth exemplary embodiment, and inputting two outputs, namely, the output of the input unit 11 and the output of the first shape slice data generation unit 165 into the differential shape data generation unit 166. The differential shape data generation unit 166 generates differential shape data based on the solid shape that is the output of the input unit 11 and the first shape slice data that is the output of the first shape slice data generation unit 165. The rest of the configuration is the same as in the fourth exemplary embodiment.

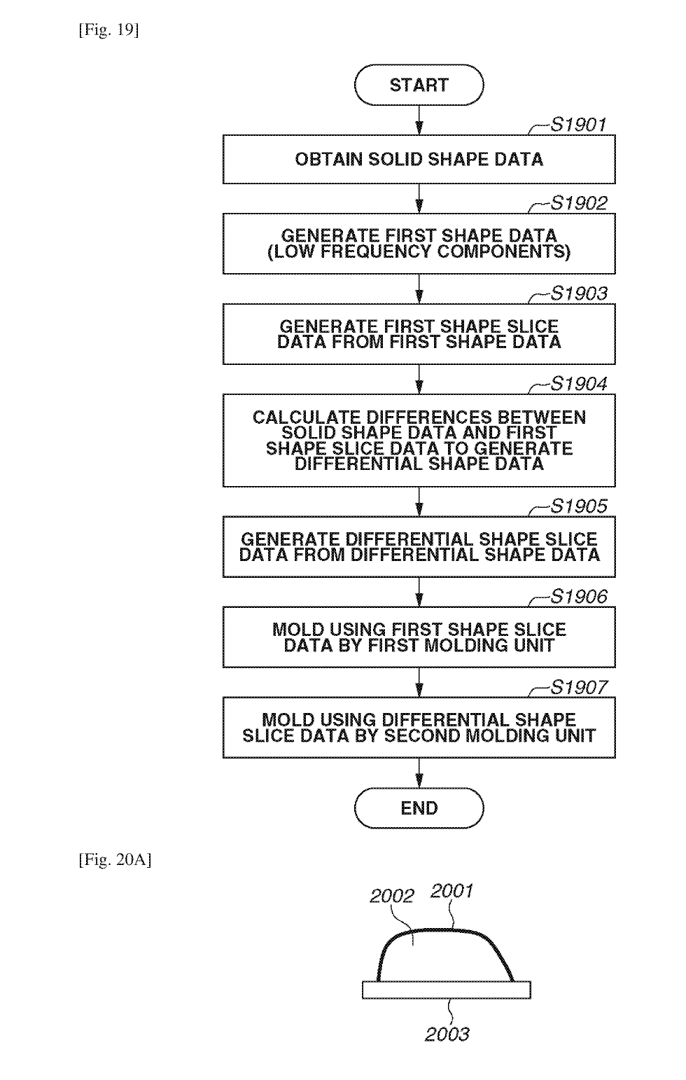

FIG. 19 is a flowchart illustrating a method for molding a solid object according to the fifth exemplary embodiment.

In step S1901, solid shape data is input. In this step, the input unit 11 obtains solid shape data (such as CAD data and design data) on an object to be molded from a computer apparatus.

In step S1902, the first shape data generation unit 164 generates first shape data having the first frequency band based on the input solid shape data. The first shape data is lower in frequency than the solid shape data.

In step S1903, the first shape slice data generation unit 165 slices the first shape data generated in step S1902 in the stacking direction of layers of molding material to generate first shape slice data. The first shape slice data includes first voxels for forming the interior of the solid object.

In step S1904, the differential shape data generation unit 166 calculates differences between the solid shape data and the first shape slice data to generate differential shape data.

In step S1905, the differential shape slice data generation unit 167 generates differential shape slice data from the differential shape data.

In step S1906, the first molding unit 32 performs molding using the first shape slice data. Like the first to fourth exemplary embodiments, the first molding unit 32 molds the first voxels (first molding).

In step S1907, the second molding unit 34 performs molding using the differential shape slice data (second molding). Like the first to fourth exemplary embodiments, the second molding unit 34 molds the second voxels.

In the first molding in step S1906 and the second molding in step S1907, in order for the molded article to be cured, the apparatus control unit 12 performs ultraviolet irradiation using the UV lamp 50.

As described in the fifth exemplary embodiment above, differences between the original solid shape data and the first shape slice data obtained by slicing the first shape data are calculated, and the second molding unit 34 performs molding based on the calculated differential shape data. The solid object can thus be molded at high speed and with high definition.

In the foregoing exemplary embodiments, examples of molding a solid object with high definition at high speed in a manner such that the interior of the solid object is molded at high speed using the first voxels of larger size and the surface of the solid object is molded with high definition using the second voxels of smaller size have been described. The exemplary embodiments are directed to molding a solid molded article with high definition at high speed, and modifications of various configurations may be employed without departing from such a purpose. For example, the first shape data may be shape data that includes the first voxels of relatively large size more than the second voxels of relatively small size and is intended to be used for molding the interior side of the solid object. The second shape data may be shape data that includes the second voxels of relatively small size more than the first voxels of relatively large size and is intended to be used for molding the surface side of the solid object. In other words, the first shape data may include not only the first voxels but also the second voxels. The second shape data may include not only the second voxels but also the first voxels.

In the foregoing exemplary embodiments, two types of shape data, such as the first shape data for molding the interior side of a solid object and the second shape data for molding the surface side of the solid object, are described to be used. However, the exemplary embodiments are similarly applicable if three or more types of shape data are generated. For example, first shape data, second shape data, and third shape data can be used to mold the innermost side of a solid object with the first shape data, an outer side with the second shape data, and the surface side of the solid object with the third shape data. In such a case, the shape data corresponding to the inner sides of the solid object can be molded with voxels of relatively larger sizes.

In the foregoing exemplary embodiments, the inkjet method is mainly described as an example. The present exemplary embodiment is not limited to the foregoing, and is similarly applicable to various types of additive manufacturing methods other than the inkjet method. Examples include stereolithography, powder sintering, powder binding (inkjet binder method), and fused deposition modeling. For example, in stereolithography, a liquid resin is irradiated with ultraviolet rays to be partly successively cured and is stacked in layers so that a solid object is molded. Such a method can provide similar effects to those of the foregoing exemplary embodiments in a manner such that liquid resin corresponding to the interior of a solid object is irradiated with ultraviolet rays of large irradiation size and liquid resin corresponding to the surface of the solid object is irradiated with ultraviolet rays of small irradiation size. In the powder sintering, powder is spread in a layer and layers of the powder directly sintered by, for example, a laser beam are staked in layers so that a solid object is molded. Such a method can provide similar effects to those of the foregoing exemplary embodiments in a manner such that the size of the laser beam for sintering powder corresponding to the interior of a solid object is increased and the size of the laser beam for sintering powder corresponding to the surface of the solid object is reduced. In the powder binding (inkjet binder method), powder is spread in a layer and layers of the powder bound by a binder applied by an inkjet method are stacked in layers so that a solid object is molded. Such a method can provide similar effects to those of the foregoing exemplary embodiments in a manner such that the amount of the binder for binding powder corresponding to the interior of a solid object is increased and the amount of the binder for binding powder corresponding to the surface of the solid object is reduced. In the fused deposition modeling, layers of thermoplastic resin (such as ABS resin and polycarbonate resin) melted at high temperature are stacked in layers so that a solid object is molded. Such a method can provide similar effects to those of the foregoing exemplary embodiments in a manner such that the volume of voxels (the amount of thermoplastic resin) for molding the interior of a solid object is increased and the volume of voxels (the amount of thermoplastic resin) for molding the surface of the solid object is reduced.

The present exemplary embodiment may be applied to not only an additive manufacturing three-dimensional (3D) printer and also a printer that reproduces an uneven shape on a support for molding (molding medium). For example, the present exemplary embodiment can be applied to the reproduction of an oil painting having uneven shapes or a diorama expressing terrains and such reproduction can be achieved by molding with high definition at high speed.

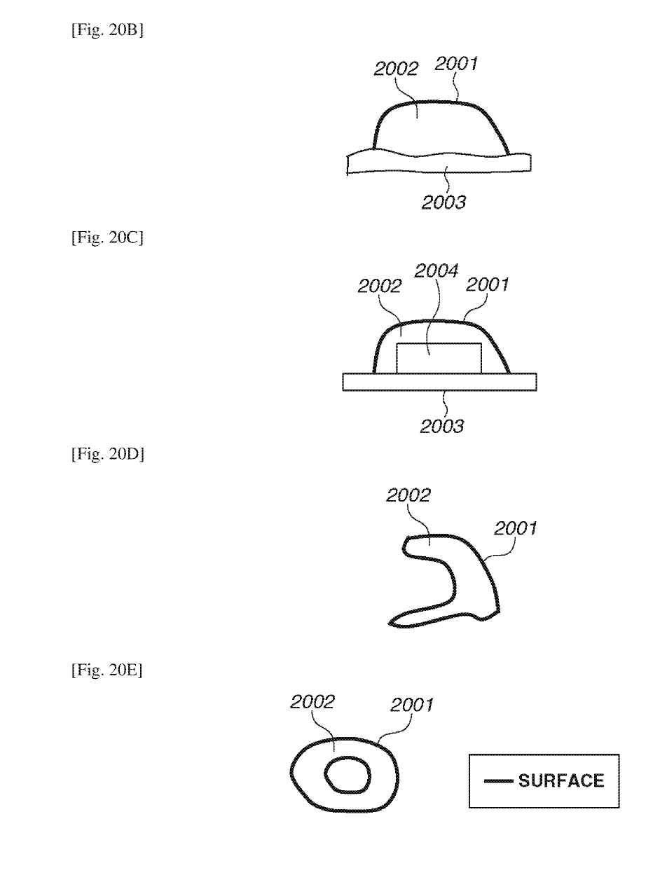

As illustrated in the cross sections of FIGS. 20A to 20E, various types of uneven shapes and solid objects can be employed in the present exemplary embodiment. In FIGS. 20A to 20E, a shape 2001 represents the surface of an uneven shape or a solid object molded in the present exemplary embodiment. A shape 2002 represents the interior of the uneven shape or solid object molded in the present exemplary embodiment. A shape 2003 represents a support. A shape 2004 represents a support material (or support base). For example, as illustrated in FIG. 20A, a solid molded article can be molded on a flat support 2003. As illustrated in FIG. 20B, a solid object can be molded on a nonflat support 2003. As illustrated in FIG. 20C, a solid object can be molded on the support material arranged on a support 2003. As illustrated in FIGS. 20D and 20E, a solid object including a recess or a solid object of cylindrical shape can be molded. In FIGS. 20A to 20E, the portions illustrated in thick lines are ones corresponding to the surface of the solid object. According to the present exemplary embodiment, such portions can be molded with high definition using small voxels. The present exemplary embodiment is not limited to the uneven shapes or solid objects illustrated in FIGS. 20A to 20E. The present exemplary embodiment is suitably applicable to various uneven shapes and solid objects.

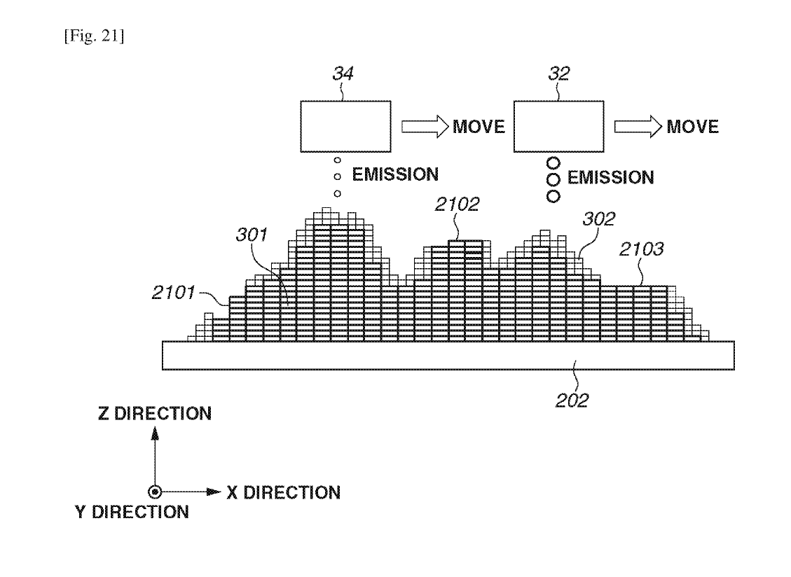

The first voxels do not necessarily need to be molded for only the interior of a solid object. For example, like first voxels 2101, 2102, and 2103 illustrated in FIG. 21, portions molded using first voxels may be exposed in part of the surface of a solid molded article. The present exemplary embodiment is characterized in that a rough shape is molded using a first molding material and fine shapes are molded using a second molding material. If a solid object has a surface of relatively smooth shape, the surface of the solid object may be molded using only the first molding material without using the second molding material which enables finer molding. In other words, in the present exemplary embodiment, it is simply the case that the portions molded using the first molding material mostly correspond to the interior of the solid object and the portions molded using the second molding material often correspond to the surface of the solid object. The effects of the present exemplary embodiment can be enjoyed if the present exemplary embodiment is applied to part of a solid object, even with some exceptional unapplied portions.

An exemplary embodiment of the present invention may be achieved by processing for supplying a program for implementing one or more of the functions of the foregoing exemplary embodiments to a system or an apparatus via a network or a storage medium, and for reading and executing the program by one or more processors in a computer of the system or apparatus. An exemplary embodiment of the present invention may be carried out by a circuit (for example, application specific integrated circuit (IC)) for implementing one or more of the functions.

According to an exemplary embodiment of the present invention, data for molding a solid object with higher definition at higher speed can be generated than the case of molding a solid object using a single type of voxels.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)(Trade mark)), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-115169, filed 2015, Jun. 5, which is hereby incorporated by reference herein in its entirety.

1. An information processing apparatus comprising:
an input unit configured to input solid shape data expressing a shape of a solid object; and
a generation unit configured to generate first data and second data from the solid shape data, the first data including a unit component in molding the solid object, the second data including a unit component to be formed using a dot of color material on a surface of a solid object expressed by the first data, the unit component of the second data being smaller than the unit component of the first data.

2. The information processing apparatus according to claim 1, wherein the first data is data for molding a rough shape of the solid object, and wherein the second data is data for molding a fine shape of the solid object.

3. The information processing apparatus according to claim 1, wherein the generation unit is configured to
generate slice data indicating a shape obtained by slicing the solid shape data in a stacking direction of layers of molding material, and
generate the first data and the second data from the slice data.

4. The information processing apparatus according to claim 3, wherein a height of a layer of the unit component expressed by the second data in the stacking direction is lower than a height of a layer of the unit component expressed by the first data in the stacking direction.

5. The information processing apparatus according to claim 1, wherein the first data expresses the unit component positioning in an interior of the solid object.

6. The information processing apparatus according to claim 1, wherein the generation unit is configured to generate the second data from a difference between the solid shape data and the first data.

7. The information processing apparatus according to claim 1, wherein the first data is shape data having a first frequency band of the solid shape data, and
wherein the second data is shape data having a second frequency band of the solid shape data, the second frequency band being higher in frequency than the first frequency band.

8. The information processing apparatus according to claim 1, further comprising a molding unit configured to mold the solid object using the first data and the second data.

9. The information processing apparatus according to claim 8, further comprising a measurement unit configured to measure a shape of the solid object molded by the molding unit,
wherein the second data is differential data between the solid shape data and a result of measurement by the measurement unit.

10. The information processing apparatus according to claim 8, wherein the molding unit is configured to mold a shape expressed by the first data and a shape expressed by the second data using the same material.

11. The information processing apparatus according to claim 10, wherein the material includes a coloring material.

12. An information processing method comprising:
inputting solid shape data expressing a shape of a solid object; and
generating first data and second data from the solid shape data, the first data including a unit component in molding the solid object, the second data including a unit component to be formed using a dot of color material on a surface of a solid object expressed by the first data, the unit component of the second data being smaller than the unit component of the first data.

13. A computer-readable non-transitory recording medium storing a program comprising:
inputting solid shape data expressing a shape of a solid object; and
generating first data and second data from the solid shape data, the first data including a unit component in molding the solid object, the second data including a unit component to be formed using a dot of color material on a surface of a solid object expressed by the first data, the unit component of the second data being smaller than the unit component of the first data.
